(19) United States
(12) Patent Application Publication
(10) Pub. No.: US 2017/0291143 A1
(43) Pub. Date: Oct. 12, 2017

(54) SEPARATION MODULES, SYSTEMS, AND METHODS

(71) Applicant: 3M INNOVATIVE PROPERTIES COMPANY, St. Paul, MN (US)

(72) Inventors: Jinsheng Zhou, Woodbury, MN (US); Ryan C. Shirk, Mendota Heights, MN (US); Kazuhiko Mizuno, Tokyo (JP); David S. Seitz, Woodbury, MN (US)

(21) Appl. No.: 15/511,714

(22) PCT Filed: Sep. 24, 2015
(86) PCT No.: PCT/US2015/051876

§ 371 Date: Mar. 16, 2017

Related U.S. Application Data
(60) Provisional application No. 62/055,880, filed on Sep. 26, 2014.
(60) Provisional application No. 62/205,068, filed on Aug. 14, 2015.

(51) Int. Cl. B01D 61/36; B01D 69/12; B01D 67/00; B01D 63/10; B01D 65/00

(52) U.S. Cl. CPC B01D 61/36; B01D 63/103; B01D 65/003; B01D 67/0088; B01D 69/12; B01D 69/125; B01D 2323/286; B01D 2323/30; B01D 2323/345; B01D 2325/022

(57) ABSTRACT

A separation module including at least one separation leaf that includes two porous composite membranes and a permeate mesh spacer sandwiched therebetween with and an edge-seal bond that adheres the membranes and spacer together.

### BACKGROUND

Separation modules that include composite membranes are known; however, there is a continual need for effective separation modules.

### SUMMARY OF THE DISCLOSURE

The present disclosure provides separation modules that include composite membranes, methods of making such modules, and methods of use of such modules in separation techniques.

Generally, a separation module includes at least one separation leaf that includes: first and second asymmetric composite membranes (that include pores) having a permeate mesh spacer (that includes mesh openings) sandwiched between the first and second asymmetric composite membranes; and an edge-seal bond (i.e., edge-sealing bond) that adheres the first and second asymmetric composite membranes and permeate spacer together. The first and second asymmetric composite membranes may be different portions of the same membrane (e.g., as in a folded membrane).

The edge-seal bond includes: a pore-filling sealant within at least a portion of the pores of the first and second membranes; and an adhesive within at least a portion of the mesh openings of the permeate spacer. In certain embodiments, the pore-filling sealant is distinct from the adhesive. In certain embodiments, the pore-filling sealant and the adhesive are the same before application, but they are applied under different conditions (e.g., different temperatures) such that they have different viscosities. Typically, such differing viscosities during application will result in distinct materials in the final product (e.g., different molecular weight distribution, different chemical structure, different filler content).

Generally, the composite membranes include a porous substrate (i.e., a support substrate that may include one or more layers) that includes opposite first and second major surfaces, and a plurality of pores; and a pore-filling polymer disposed in at least some of the plurality of pores so as to form a layer having a thickness within the porous substrate. In certain embodiments the layer is a continuous layer. Such composite membranes may be asymmetric. By “asymmetric,” it is meant that the amount of the polymer at or adjacent to the first major surface is greater than the amount of the polymer at or adjacent to the second major surface.

Such modules include asymmetric composite membranes that are particularly useful for separation of components within a fluid (typically, a liquid). In certain embodiments, modules of the present disclosure are useful for selectively pervaporating a first liquid from a mixture that includes the first liquid and a second liquid, generally because the pore-filling polymer of the asymmetric composite membrane is more permeable to the first liquid than the second liquid. In one embodiment, the present disclosure provides a separation module that includes first and second asymmetric composite membranes for selectively pervaporating alcohol from an alcohol and gasoline mixture.

The present disclosure provides a fuel separation system that includes a separation module as described herein.

The present disclosure also provides methods of use. For example, the present disclosure provides a method of separating a first liquid (e.g., ethanol) from a mixture of the first liquid (e.g., ethanol) and a second liquid (e.g., gasoline), the method including contacting the mixture with a separation module as described herein.

The present disclosure also provides methods of making. For example, the present disclosure provides a method of making a separation module that includes at least one separation leaf including first and second asymmetric composite membranes having a permeate spacer sandwiched between the first and second asymmetric composite membranes, wherein the first and second asymmetric composite membranes include pores and the permeate spacer includes mesh openings. The method includes: applying a pore-filling sealant adjacent to at least one edge of each membrane, wherein the pore-filling sealant has a viscosity sufficient to fill at least a portion of the pores of the membrane; applying an adhesive adjacent to at least one edge of the permeate spacer, wherein the adhesive has a viscosity sufficient to fill at least a portion of the mesh openings of the permeate spacer; and forming an edge-seal bond between the pore-filling sealant and adhesive that adheres the first and second asymmetric composite membranes and permeate spacer together. In such method, the pore-filling sealant viscosity is lower than the adhesive viscosity when applied. This can result from applying the same composition for the pore-filling sealant and the adhesive, but at different temperatures. Alternatively, this can result from applying distinct compositions for the pore-filling sealant and adhesive.

The terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the organic material. These configurations include, but are not limited to, isotactic, syndiotactic, and atactic symmetries.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to claims of the disclosure that may afford certain benefits, under certain circumstances. However, other claims may also be preferred, under the same or other circumstances. Furthermore, the recitation of one or more preferred claims does not imply that other claims are not useful, and is not intended to exclude other claims from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the term “room temperature” refers to a temperature of 20° C. to 25° C. or 22° C. to 25° C.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### BRIEF DESCRIPTION OF THE DRAWINGS

FIG. 1 is a cross-sectional schematic view of an exemplary porous substrate 10 and an asymmetric composite membrane 30 of the present disclosure.

FIG. 2 is a perspective side view of an exemplary separation module of the present disclosure.

FIG. 3 is an illustration of an exemplary fuel separation system that includes an exemplary separation module of the present disclosure.

FIG. 4 is an illustration of a cross-section of an exemplary single-leaf spiral-wound separation module of the present disclosure.

FIG. 5 is an illustration of an exploded view of an exemplary multi-leaf spiral-wound separation module of the present disclosure.

FIG. 6 is a graph of material volume versus soaking time for several materials tested according to the Swelling Test.

### DETAILED DESCRIPTION OF ILLUSTRATIVE EMBODIMENTS

The present disclosure provides separation modules that include asymmetric composite membranes. Generally, a separation module includes at least one separation leaf that includes two porous composite membranes and a permeate mesh spacer sandwiched therebetween with and an edge-seal bond that adheres the membranes and spacer together.

More specifically, a separation module includes at least one separation leaf. A separation leaf includes: first and second asymmetric composite membranes (that include pores) having a permeate mesh spacer (that includes mesh openings) sandwiched between the first and second asymmetric composite membranes; and an edge-seal bond that adheres the first and second asymmetric composite membranes and permeate spacer together. In certain embodiments, e.g., for a single-leaf module, the first and second asymmetric composite membranes may be different portions of the same membrane (e.g., as in a folded membrane).

The edge-seal bond includes a pore-filling sealant within at least a portion of the pores of the first and second membranes, and an adhesive within at least a portion of the mesh openings of the permeate spacer. In certain embodiments, the pore-filling sealant is distinct from the adhesive. In certain embodiments, the pore-filling sealant and the adhesive are the same before application, but they are applied under different conditions (e.g., different temperatures) such that they have different viscosities. Typically, such differing viscosities during application will result in distinct materials in the final product (e.g., different molecular weight distribution). Preferably, the pore-filling sealant and the adhesive of the edge-seal bond do not swell in the presence of a fluid (typically, a liquid) to be filtered under separation conditions. Thus, the combination of the pore-filling sealant and the adhesive of the edge-seal bond effectively prevents micro-leaks at the edges of the separation module.

Separation modules that include at least one separation leaf (e.g., with two separation membranes and a permeate spacer sandwiched therebetween) need to have the edges well sealed to prevent leakage. Adhesives have been used in conventional separation modules, but such adhesives may not penetrate porous microstructures of the membrane and/or spacer sufficiently to prevent micro-leaks. A low viscosity adhesive with good flow properties could correct this problem, but such adhesive is challenging to seal a coarse and thick mesh without spreading out to give a wider and defect-free sealing band. A wider sealing band could reduce, but not completely eliminate, micro-leaking due to the presence of cross-sealing band micropores. Also, a wider sealing band reduces the use efficiency of membrane area since the selective layer in sealing area functions little or not at all during operation. Large amounts of adhesive have also been used to correct this problem, but using a large amount of an adhesive results in a non-uniform thickness, which can result in problems winding a membrane leaf around a core tube in a spiral-wound separation module.

The present disclosure provides a solution to the problem of micro-leaking in separation modules, particularly spiral-wound separation modules by using a pore-filling sealant and an adhesive. The pore-filling sealant has a relatively low viscosity during application to allow it to impregnate into at least micro-pores (and possibly even the nano-pores) of an asymmetric composite membrane. The adhesive has a relatively high viscosity during application to allow it to impregnate the permeate spacer without penetrating into the micro- or nano-pores of the asymmetric composite membrane (although some penetration into the macro-pores of the asymmetric composite membrane may be acceptable). Upon curing, both the pore-filling sealant and the adhesive within the edge-seal bond are of a sufficient flexibility to allow manipulation of the asymmetric composite membrane bonded to the permeate spacer without cracking or breakage of the bond (e.g., as in an edge-trimming process or a winding process of a spiral-wound separation module).

Such separation modules of the present disclosure can be in the form of spiral-wound separation modules, plate and frame separation modules, tubular separation modules, hollow fiber separation modules, pleated separation modules, and the like. Preferred separation modules of the present disclosure are spiral-wound separation modules. Examples of such modules, and methods of edge sealing, are described in U.S. Pat. No. 4,464,494 (King et al.), U.S. Pat. No. 4,582,726 (Shuey et al.), U.S. Pat. No. 5,069,793 (Kaschemekat et al.), U.S. Pat. No. 5,275,726 (Feimer et al.), and U.S. Pat. No. 6,068,771 (McDermott et al.), as well as EP 1 637 214 (Nitto Denko Corp.).

Separation modules of the present disclosure may be used in various separation methods, including pervaporation, gas separation, vapor permeation, organic solvent nanofiltration, and fluid (particularly, liquid) separation. The preferred separation modules of the present disclosure are particularly useful in pervaporation methods.

Pervaporation is a process that involves a membrane in contact with a liquid on the feed or upstream side and a vapor on the “permeate” or downstream side. Usually, a vacuum or an inert gas is applied on the vapor side of the membrane to provide a driving force for the process. Typically, the downstream pressure is lower than the saturation pressure of the permeate.

Vapor permeation is quite similar to pervaporation, except that a vapor is contacted on the feed side of the membrane instead of a liquid. As membranes suitable for pervaporation separations are typically also suitable for vapor permeation separations, use of the term “pervaporation” may encompass both “pervaporation” and “vapor permeation.”

Pervaporation may be used for desulfurization of gasoline, dehydration of organic solvents, isolation of aroma compounds or components, and removal of volatile organic compounds from aqueous solutions. In certain embodiments of the present disclosure, the separation modules are used for pervaporating alcohol from an alcohol and gasoline mixture.

Such separation modules are particularly useful for selectively pervaporating a first liquid from a mixture that includes the first liquid and a second liquid, generally because the pore-filling polymer of the asymmetric composite membrane is more permeable to the first liquid than the second liquid. Furthermore, the pore-filling polymer is not soluble in the liquids to which it comes in contact during use.

In certain embodiments, the first liquid may be water, an alcohol (such as ethanol, methanol, 1-propanol, 2-propanol, 1-methoxy-2-propanol, or butanol), or an organic sulfur-containing compound (such as thiophene, tetrahydrothiophene, benzothiophene, 2-methylthiophene, or 2,5-dimethylthiophene). In certain embodiments, the second liquid may be gasoline, benzene, an ester (such as methyl-tert-butylether, ethyl-tert-butylether), hexane, or cyclohexane. In certain embodiments, the first liquid is an alcohol, and the second liquid is gasoline.

### Asymmetric Composite Membranes

There is a need for separation modules with highly selective membranes. Traditional composite membranes include a selective thin polymer coating supported on an underlying porous support. Such selective layers will absorb one or more components in a mixture to be separated, which causes their swelling. The swelling will not only decrease mechanical strength but also affect membrane performance. Introduction of chemical crosslinking density or impermeable physical regions could restrain the material swelling to some extent, but this may reduce the permeability. Thus, there is a challenge to create a membrane with effective pervaporation performance and mechanical strength. Also, it is challenging to apply a very thin coating without causing defects or pinholes. One or more composite membranes of the present disclosure have solved one or more of these problems and provide an appropriate balance of properties.

In certain embodiments, an asymmetric composite membrane includes a porous substrate of different layers of polymeric material of different porosity. For example, an exemplary commercially available asymmetric composite membrane includes a polyamide nonporous layer, a polyester macroporous layer, and a polysulfone microporous layer sandwiched therebetween. Other exemplary asymmetric composite membranes are described in U.S. Pat. No. 4,277,344 (Cadotte) and U.S. Pat. No. 8,597,518 (Parnas et al.).

In certain embodiments, an asymmetric composite membrane includes an integrally asymmetric membrane, which includes a selective layer and a nanoporous/microporous layer from the same polymeric membrane. Such exemplary asymmetric composite membrane is described in EP Patent Document EP0326076 (Tang et al.). In certain embodiments, an exemplary asymmetric composite membrane includes a porous substrate and a pore-filling polymer. The porous substrate (which may be in the form of one or more porous layers) has opposite first and second major surfaces, and a plurality of pores. The pore-filling polymer is disposed in at least some of the plurality of pores so as to form a layer having a thickness within the porous substrate. In certain embodiments, the pore-filling polymer layer is preferably a continuous layer. The amount of the pore-filling polymer at or adjacent to the first major surface is greater than the amount of the pore-filling polymer at or adjacent to the second major surface. Hence, a composite membrane is asymmetric with respect to the amount of pore-filling polymer throughout the thickness of the porous substrate.

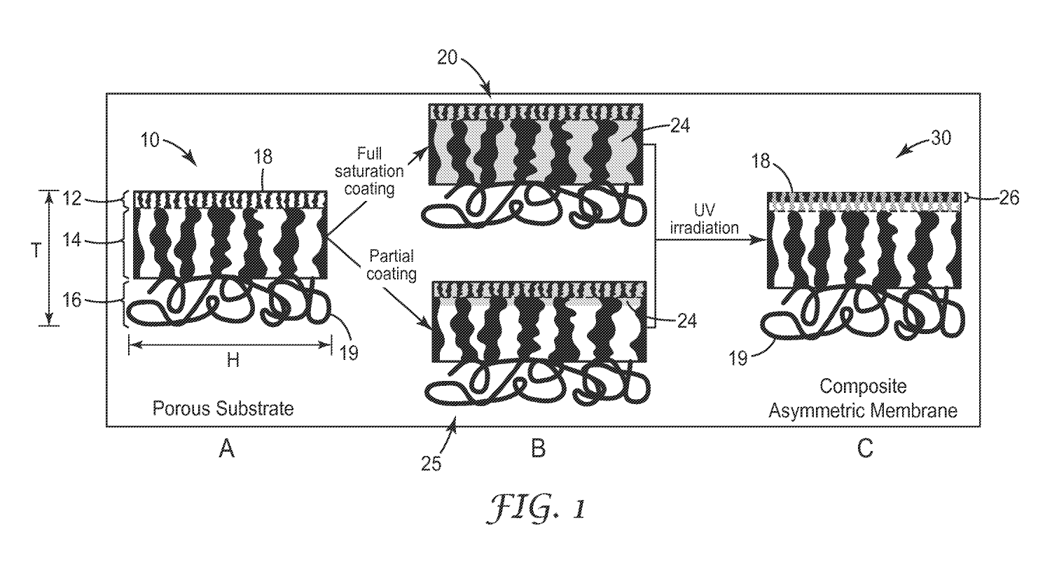

Referring to FIG. 1, illustrations of an exemplary porous substrate 10 (FIG. 1A) and an exemplary asymmetric composite membrane 30 (FIG. 1C), with intermediates 20 and 25 (FIG. 1B), are shown in vertical cross-section. The exemplary porous substrate 10 includes three layers that include a nanoporous layer 12, a microporous layer 14, and a macroporous layer 16 (FIG. 1A) having a first major surface 18 and a second major surface 19. During processing, various intermediates could be formed. Two examples of intermediates are shown as 20 and 25 in FIG. 1B. The porous substrate 10 may be fully saturated with a curable pore-filling polymer composition 24 to create intermediate 20 (top panel of FIG. 1B), or the porous substrate 10 may be only partially filled with a curable pore-filling polymer composition 24 to create intermediate 25 (bottom panel of FIG. 1B). That is, the curable pore-filling polymer composition 24 may be disposed in at least some of the plurality of pores. Once the curable (i.e., polymerizable and/or crosslinkable) pore-filling polymer composition 24 is exposed to a radiation source, such as an ultraviolet radiation source, and cured (i.e., polymerized and/or crosslinked), and the uncured pore-filling polymer composition washed away (if there is any), a pore-filling polymer layer 26 is formed. That is, whether the porous substrate is initially fully saturated with (as in intermediate 20), or only partially filled with (as in intermediate 25), the pore-filling polymer, upon being cured and the uncured portion washed away, forms a polymer layer 26. In certain embodiments, this polymer layer 26 has a thickness and is formed within the porous substrate 10, such that the amount of the polymer at or adjacent to the first major surface 18 is greater than the amount of the polymer at or adjacent to the second major surface 19, thereby forming an exemplary asymmetric composite membrane 30 of the present disclosure (FIG. 1C).

In a porous substrate 10, the pores are interconnected vertically (i.e., throughout the thickness ‘T’ of the porous substrate 10, see FIG. 1A). In certain preferred embodiments, the pores of the porous substrate 10 are interconnected horizontally (e.g., as in a microfiltration membrane) along dimension “H” (see FIG. 1A). In such embodiments, the pore-filling polymer layer 26 (FIG. 1C) formed by the pore-filling polymer 24 is preferably a continuous layer. If the pores of the porous substrate 10 are not all interconnected horizontally (along dimension “H”), the layer 26 is discontinuous (i.e., the pore-filling polymer forms a plurality of discreet regions within the porous substrate). It will be understood that dimension “H” generally refers to the plane of the porous substrate and is exemplary of all the various horizontal dimensions within a horizontal slice of the substrate (shown in vertical cross-section). Whether layer 26 is continuous or discontinuous, for the asymmetric composite membrane, the amount of the pore-filling polymer at or adjacent to the first major surface 18 is greater than the amount of the polymer at or adjacent to the second major surface 19.

As used herein, a continuous layer refers to a substantially continuous layer as well as a layer that is completely continuous. A substantially continuous layer is a layer that is continuous enough that the asymmetric composite membrane is able to selectively pervaporate a desired amount of the first liquid (e.g., alcohol) from a mixture of the first liquid with a second liquid (e.g., gasoline). In particular, the flux and the selectivity of the composite membrane (with a “continuous layer” of pore-filling polymer) is sufficient for the particular system in which the membrane is used.

### Porous Substrates of Asymmetric Composite Membranes

The porous substrate itself of the asymmetric composite membranes described herein may be asymmetric or symmetric. The porous substrate may include one layer or multiple layers. For example, there may be two, three, four, or more layers. In some embodiments, the porous substrate is hydrophobic. In other embodiments, the porous substrate is hydrophilic.

If the porous substrate is asymmetric (before being combined with the pore-filling polymer), the first and second major surfaces have porous structures with different pore morphologies. For example, the porous substrate may have pores of differing sizes throughout its thickness. Analogously, if the porous substrate is symmetric (before being combined with the pore-filling polymer), the major surfaces have porous structures wherein their pore morphologies are the same. For example, the porous substrate may have pores of the same size throughout its thickness.

Referring to FIG. 1A, an asymmetric substrate is shown with different pore morphologies at the first major surface 18 and the second major surface 19. More specifically, there are three layers each of different pore size such that the overall substrate has pores of differing sizes throughout its thickness “T.” In certain embodiments, nanoporous layer 12 alone could function as the porous substrate. In such embodiments, the porous substrate would be symmetric.

Suitable porous substrates include, for example, films, porous membranes, woven webs, nonwoven webs, hollow fibers, and the like. For example, the porous substrates may be made of one or more layers that include films, porous films, microfiltration membranes, ultrafiltration membranes, nanofiltration membranes, woven materials, and nonwoven materials. The materials that may be used for each of the above-mentioned supports may be organic in nature (such as the organic polymers listed below), inorganic in nature (such as aluminum, steels, and sintered metals and or ceramics and glasses), or a combination thereof. For example, the porous substrate may be formed from polymeric materials, ceramic and glass materials, metal, and the like, or combinations (i.e., mixtures and copolymers) thereof.

In composite membranes of the separation modules of the present disclosure, materials that withstand hot gasoline environment and provide sufficient mechanical strength to the composite membranes are preferred. Materials having good adhesion to each other are particularly desirable. In certain embodiments, the porous substrate is preferably a polymeric porous substrate.

Suitable polymeric materials include, for example, polystyrene, polyolefins, polyisoprenes, polybutadienes, fluorinated polymers (e.g., polyvinylidine difluoride (PVDF), ethylene-co-chlorotrifluoroethylene copolymer (ECTFE)), polyvinyl chlorides, polyesters, polyamides (e.g., various nylons), polyimides, polyethers, poly(ether sulfone)s, poly(sulfone)s, poly(phenylene sulfone)s, polyphenylene oxides, polyphenylene sulfides (PPS), poly(vinyl acetate)s, copolymers of vinyl acetate, poly(phosphazene)s, poly(vinyl ester)s, poly(vinyl ether)s, poly(vinyl alcohol)s, polycarbonates, polyacrylonitrile, polyethylene terephthalate, cellulose and its derivatives (such as cellulose acetate), and the like, or combinations (i.e., mixtures or copolymers) thereof.

Suitable polyolefins include, for example, poly(ethylene), poly (propylene), poly(1-butene), copolymers of ethylene and propylene, alpha olefin copolymers (such as copolymers of 1-butene, 1-hexene, 1-octene, and 1-decene), poly(ethylene-co-1-butene), poly(ethylene-co-1-butene-co-1-hexene), and the like, or combinations (i.e., mixtures or copolymers) thereof.

Suitable fluorinated polymers include, for example, polyvinylidine difluoride (PVDF), poly(vinyl fluoride), poly(vinylidene fluoride), copolymers of vinylidene fluoride (such as poly(vinylidene fluoride-co-hexafluoropropylene)), copolymers of chlorotrifluoroethylene (such as ethylene-co-chlorotrifluoroethylene copolymer), and the like, or combinations (i.e., mixtures or copolymers) thereof.

Suitable polyamides include, for example, poly(imino(1-oxohexamethylene)), poly(iminoadipoylimino hexamethylene), poly(iminoadipoylimindecamethylene), polycaprolactam, and the like, or combinations thereof

Suitable polyimides include, for example, poly(pyromellitimide), polyetherimide, and the like.

Suitable poly(ether sulfone)s include, for example, poly(diphenylether sulfone), poly(diphenylsulfone-co-diphenylene oxide sulfone), and the like, or combinations thereof.

Suitable polyethers include, for example, polyetherether ketone (PEEK).

Such materials may be photosensitive or non-photosensitive. Photosensitive porous substrate materials may act as a photoinitiator and generate radicals which initiate polymerization under radiation sources, such as UV radiation, so that the filled polymer could covalently bond to the porous substrate. Thus, crosslinking within the pore-filling polymer is not necessary to strongly hold the filled polymer to the substrate, since this could result in the polymer being bonded or tethered to the substrate walls. Suitable photosensitive materials include, for example, polysulfone, polyethersulfone, polyphenylenesulfones, PEEK, polyimide, and PPS. Photosensitive materials are preferably used for nanoporous layers.

Suitable porous substrates may have pores of a wide variety of sizes. For example, suitable porous substrates may include nanoporous membranes, microporous membranes, microporous nonwoven/woven webs, microporous woven webs, microporous fibers, nanofiber webs, and the like. In some embodiments, the porous substrate may have a combination of different pore sizes (e.g., micropores, nanopores, and the like). In one embodiment, the porous substrate is microporous.

In some embodiments, the porous substrate includes pores that may have an average pore size less than 10 micrometers (μm). In other embodiments, the average pore size of the porous substrate may be less than 5 μm, or less than 2 μm, or less than 1 μm.

In other embodiments, the average pore size of the porous substrate may be greater than 10 nm (nanometer). In some embodiments, the average pore size of the porous substrate is greater than 50 nm, or greater than 100 nm, or greater than 200 nm.

In certain embodiments, the porous substrate includes pores having an average size in the range of from 0.5 nm up to and including 1000 μm. In some embodiments, the porous substrate may have an average pore size in a range of 10 nm to 10 μm, or in a range of 50 nm to 5 μm, or in a range of 100 nm to 2 μm, or in a range of 200 nm to 1 μm.

In certain embodiments, the porous substrate includes a nanoporous layer. In certain embodiments, the nanoporous layer is adjacent to or defines the first major surface of the porous substrate. In certain embodiments, the nanoporous layer includes pores having a size in the range of from 0.5 nanometer (nm) up to and including 100 nm. In accordance with the present disclosure, the size of the pores in the nanoporous layer may include, in increments of 1 nm, any range between 0.5 nm and 100 nm. For example, the size of the pores in the nanoporous layer may be in the range of from 0.5 nm to 50 nm, or 1 nm to 25 nm, or 2 nm to 10 nm, etc. Molecular Weight Cut-Off (MWCO) is typically used to correlate to the pore size. That is, for nanopores, the molecular weight of a polymer standard (retain over 90%) such as dextran, polyethylene glycol, polyvinyl alcohol, proteins, polystyrene, poly(methylmethacrylate) may be used to characterize the pore size. For example, one supplier of the porous substrates evaluates the pore sizes using a standard test, such as ASTM E1343-90-2001 using polyvinyl alcohol.

In certain embodiments, the porous substrate includes a microporous layer. In certain embodiments, the microporous layer is adjacent to or defines the first major surface of the porous substrate. In certain embodiments, the microporous layer includes pores having a size in the range of from 0.01 μm up to and including 20 μm. In accordance with the present disclosure, the size of the pores in the microporous layer may include, in increments of 0.05 μm, any range between 0.01 μm up and 20 μm. For example, the size of the pores in the microporous layer may be in the range of from 0.05 μm to 10 μm, or 0.1 μm to 5 μm, or 0.2 μm to 1 μm, etc. Typically, the pores in the microporous layer may be measured by mercury porosimetry for average or largest pore size, bubble point pore size measurement for the largest pores, Scanning Electron Microscopy (SEM) and/or Atom Force Microscopy (AFM) for the average/largest pore size.

In certain embodiments, the porous substrate includes a macroporous layer. In certain embodiments, the macroporous layer is adjacent to or defines the first major surface of the porous substrate. In certain embodiments, the macroporous layer is embedded between two microporous layers, for example, a BLA020 membrane obtained from 3M Purification Inc.

In certain embodiments, the macroporous layer comprises pores having a size in the range of from 1 μm and 1000 μm. In accordance with the present disclosure, the size of the pores in the macroporous layer may include, in increments of 1 μm, any range between 1 μm up to and including 1000 μm. For example, the size of the pores in the macroporous substrate may be in the range of from 1 μm to 500 μm, or 5 μm to 300 μm, or 10 μm to 100 μm, etc. Typically, the size of the pores in the macroporous layer may be measured by Scanning Electron Microscopy, or Optical Microscopy, or using a Pore Size Meter for Nonwovens.

The macroporous layer is typically preferred at least because the macropores not only provide less vapor transport resistance, compared to microporous or nanoporous structures, but the macroporous layer can also provide additional rigidity and mechanical strength.

The thickness of the porous substrate selected may depend on the intended application of the membrane. Generally, the thickness of the porous substrate (“T” in FIG. 1A) may be greater than 10 micrometers (μm). In some embodiments, the thickness of the porous substrate may be greater than 1,000 μm, or greater than 5,000 μm. The maximum thickness depends on the intended use, but may often be less than or equal to 10,000 μm.

In certain embodiments, the porous substrate has first and second opposite major surfaces, and a thickness measured from one to the other of the opposite major surfaces in the range of from 5 μm up to and including 500 μm. In accordance with the present disclosure, the thickness of the porous substrate may include, in increments of 25 μm, any range between 5 μm and 500 μm. For example, the thickness of the porous substrate may be in the range of from 50 μm to 400 μm, or 100 μm to 300 μm, or 150 μm to 250 μm, etc.

In certain embodiments, the nanoporous layer has a thickness in the range of from 0.01 μm up to and including 10 μm. In accordance with the present disclosure, the thickness of the nanoporous layer may include, in increments of 50 nm, any range between 0.01 μm and 10 μm. For example, the thickness of the nanoporous layer may be in the range of from 50 nm to 5000 nm, or 100 nm to 3000 nm, or 500 nm to 2000 nm, etc.

In certain embodiments, the microporous layer has a thickness in the range of from 5 μm up to and including 300 μm. In accordance with the present disclosure, the thickness of the microporous layer may include, in increments of 5 μm, any range between 5 μm and 300 μm. For example, the thickness of the microporous layer may be in the range of from 5 μm to 200 μm, or 10 μm to 200 μm, or 20 μm to 100 μm, etc.

In certain embodiments, the macroporous layer has a thickness in the range of from 25 μm up to and including 500 μm. In accordance with the present disclosure, the thickness of the macroporous layer may include, in increments of 25 μm, any range between 25 μm and 500 μm. For example, the thickness of the macroporous substrate may be in the range of from 25 μm to 300 μm, or 25 μm to 200 μm, or 50 μm to 150 μm, etc.

In certain embodiments, there may be anywhere from one to four layers in any combination within a porous substrate. The individual thickness of each layer may range from 5 nm to 1500 μm in thickness.

In certain embodiments, each layer may have a porosity that ranges from 0.5% up to and including 95%.

### Pore-Filling Polymers of Asymmetric Composite Membranes

In general, the pore-filling polymer is insoluble in the liquids in which it comes into contact during use. More specifically, the pore-filling polymer is more permeable to a first liquid than a second liquid, but it is not soluble in the first liquid or the second liquid. As used herein, the polymer is considered to be insoluble in the first liquid (particularly, alcohol) or the second liquid (particularly, gasoline), even if insignificant amounts of the polymer are soluble in the liquids.

In certain embodiments, the pore-filling polymer is in the form of a pore-filling polymer layer 26 (FIG. 1C) that forms at least a portion of the first major surface 18 of the porous substrate. In certain embodiments, the pore-filling polymer is in the form of a pore-filling polymer layer having an exposed major surface, which coats the first major surface of the porous substrate, and an opposite major surface disposed between the opposite first and second major surfaces of the porous substrate. In certain embodiments, the exposed major surface of the pore-filling polymer layer coats all the first major surface of the porous substrate.

In certain embodiments, the pore-filling polymer forms a coating on (i.e., covers) the top surface of the substrate in addition to being within the pores of the substrate. This coating layer may be 1 micron thick. This top coating layer may be continuous or discontinuous.

That is, as used herein, any reference to the pore-filling polymer layer coating or covering the first major surface of the porous substrate includes the pore-filling polymer layer coating all, substantially all, or only a portion of the first major surface of the porous substrate. The pore-filling polymer layer is considered to coat substantially all of the first major surface of the porous substrate (i.e., be substantially continuous), when enough of the first major surface of the porous substrate is coated such that the composite membrane is able to selectively pervaporate a desired amount of a first liquid (e.g., alcohol) from a mixture of the first liquid with a second liquid (e.g., gasoline).

In certain embodiments, the pore-filling polymer layer has a thickness in the range of from 10 nm up to and including 20,000 nm. More specifically, the thickness of the pore-filling polymer layer may include, in increments of 1 nm, any range between 10 nm and 20,000 nm. For example, the thickness of the pore-filling polymer layer may be in the range of from 11 nm to 5999 nm, or 20 nm to 6000 nm, or 50 nm to 5000 nm, etc.

The pore-filling polymer may be crosslinked. It may be grafted to the porous (substrate) membrane (e.g., which may be in the form of a nanoporous layer). Or, it may be crosslinked and grafted to the porous substrate (e.g., nanoporous layer).

In certain embodiments, the pore-filling polymer may swell in the presence of alcohol (e.g., ethanol) but not gasoline. When the pore-filling polymer swells in the presence of the alcohol, the resultant alcohol-swollen polymer may be referred to as a gel.

In certain embodiments, the starting materials for the pore-filling polymer include ethylenically unsaturated monomers and/or oligomers.

In certain embodiments, the starting materials for the pore-filling polymer include (meth)acrylate-containing monomers and/or oligomers. Suitable (meth)acrylate-containing monomers and/or oligomers may be selected from the group of a polyethylene glycol (meth)acrylate, a polyethylene glycol di(meth)acrylate, a silicone diacrylate, a silicone hexa-acrylate, a polypropylene glycol di(meth)acrylate, an ethoxylated trimethylolpropane triacrylate, a hydroxylmethacrylate, 1H,1H,6H,6H-perfluorohydroxyldiacrylate, a urethane diacrylate, a urethane hexa-acrylate, a urethane triacrylate, a polymeric tetrafunctional acrylate, a polyester penta-acrylate, an epoxy diacrylate, a polyester triacrylate, a polyester tetra-acrylate, an amine-modified polyester triacrylate, an alkoxylated aliphatic diacrylate, an ethoxylated bisphenol di(meth)acrylate, a propoxylated triacrylate, and 2-acrylamido-2-methylpropanesulfonic acid (AMPS). Various combinations of such monomers and/or oligomers may be used to form the pore-filling polymer.

In certain embodiments, the (meth)acrylate-containing monomers and/or oligomers may be selected from the group of a polyethylene glycol (meth)acrylate, a polyethylene glycol di(meth)acrylate, a silicone diacrylate, a silicone hexa-acrylate, a polypropylene glycol di(meth)acrylate, an ethoxylated trimethylolpropane triacrylate, a hydroxylmethacrylate, 1H,1H,6H,6H-perfluorohydroxyldiacrylate, and a polyester tetra-acrylate. Various combinations of such monomers and/or oligomers may be used to form the pore-filling polymer.

In certain embodiments, the pore-filling polymer is a polyethylene glycol (PEG) polymer or copolymer.

In certain embodiments, the pore-filling polymer includes a major amount of crosslinked multifunctional (meth)acrylate. For example, an asymmetric composite membrane of the present disclosure may include: a porous substrate having opposite first and second major surfaces, and a plurality of pores; and a pore-filling polymer disposed in at least some of the pores so as to form a continuous layer having a thickness, with the amount of the pore-filling polymer at or adjacent to the first major surface being greater than the amount of the pore-filling polymer at or adjacent to the second major surface, wherein the pore-filling polymer comprises a major amount of crosslinked multifunctional (meth)acylate.

In some embodiments, the pore-filling polymer may include a particulate or a plurality of particulates. Examples of suitable particulates include colloidal silica, titanium oxide, and zirconium oxide. In certain embodiments, such particulates may have a particle size of 2 nm to 50 nm. They may be used as bridges to prevent collapse of the filled polymer and/or be selective for particular liquids (e.g., ethanol).

Other optional additives that may be included in the pore-filling polymers include photoinitiators. Exemplary photoinitiators for initiating free-radical polymerization of (meth)acrylates, for example, include benzoin and its derivatives such as alpha-methylbenzoin; alpha-phenylbenzoin; alpha-allylbenzoin; alpha-benzylbenzoin; benzoin ethers such as benzil dimethyl ketal (available, for example, under the trade designation IRGACURE 651 from Ciba Specialty Chemicals, Tarrytown, N.Y.), benzoin methyl ether, benzoin ethyl ether, benzoin n-butyl ether; acetophenone and its derivatives such as 2-hydroxy-2-methyl-1-phenyl-1-propanone (available, for example, under the trade designation DAROCUJR 1173 from Ciba Specialty Chemicals) and 1-hydroxycyclohexyl phenyl ketone (available, for example, under the trade designation IRGACURE 184 from Ciba Specialty Chemicals); 2-methyl-1-[4-(methylthio)phenyl]-2-(4-morpholinyl)-1-propanone (available, for example, under the trade designation IRGACURE 907 from Ciba Specialty Chemicals); 2-benzyl-2-(dimethlamino)-1-[4-(4-morpholinyl)phenyl]-1-butanone (available, for example, as IRGACURE 369 from Ciba Specialty Chemicals). Other useful photoinitiators include pivaloin ethyl ether, anisoin ethyl ether; anthraquinones, such as anthraquinone, 2-ethylanthraquinone, 1-chloroanthraquinone, 1,4-dimethyl anthraquinone, 1-methoxyanthraquinone, benzanthraquinonehalomethyltriazines; benzophenone and its derivatives; iodonium salts and sulfonium salts; titanium complexes such as bis(eta₅-2,4-cyclopentadien-1-yl)bis[2,6-difluoro-3-(1H-pyrrol-1-yl)phenyl]titanium (obtained under the trade designation CGI 784 DC, also from Ciba Specialty Chemicals); halomethylnitrobenzenes such as, for example, 4-bromomethylnitrobenzene; mono- and bis-acylphosphines (available, for example, from Ciba Specialty Chemicals as IRGACURE 1700, IRGACURE 1800, IRGACURE 1850, and DAROCUR 4265).

### Methods of Making Asymmetric Composite Membranes

Well-known techniques may be used to make the asymmetric composite membranes of the present disclosure.

Typically, a curable pore-filling polymer composition (i.e., “pore-filling polymer coating solution” or simply “pore-filling coating solution”) may be prepared by one or more monomers and/or oligomers with optional additives in a suitable amount of a liquid (e.g., deionized water or organic solvents). If an organic solvent is used, it may include dibutyl sebecate, glycerol triacetate, methanol, ethanol, propanol, isopropanol, etc. It may be a volatile organic solvent for easy solution saturation or diffusion into the pores.

The pore-filling coating solution may be applied to a selected porous substrate by a variety of techniques such as dip coating, gravure coating, die coating, slot coating, etc. Monomer and/or oligomer concentration may range from 0.5% to 100% monomer with polar groups or charged groups such as 2-acrylamido-2-methylpropanesulfonic acid (AMPS) being added into the coating solution to increase ethanol selectivity.

For example, a porous substrate may be saturated in a pore-filling coating solution of monomers and/or oligomers of a pore-filling polymer (e.g., a polyethylene glycol diacrylate, etc.) in de-ionized water. Typically, the substrate may be separated from the liquid (e.g., volatile organic solvent) before or after irradiation. Preferably, upon removal from the solution, the substrate may be exposed to irradiation, such as NV irradiation. This can be done, for example, on a moving belt. Any uncured pore-filling coating solution may be washed away, and then the composite membrane dried.

Suitable methods for preparing preferred asymmetric composite membranes of the present disclosure are described in International Publication No. WO 2010/002501 (Zhou et al.).

### Separation Modules

Modules (i.e., cartridges) of the present disclosure can be in the form of spiral-wound separation modules, plate and frame separation modules, tubular separation modules, hollow fiber separation modules, pleated separation modules, and the like.

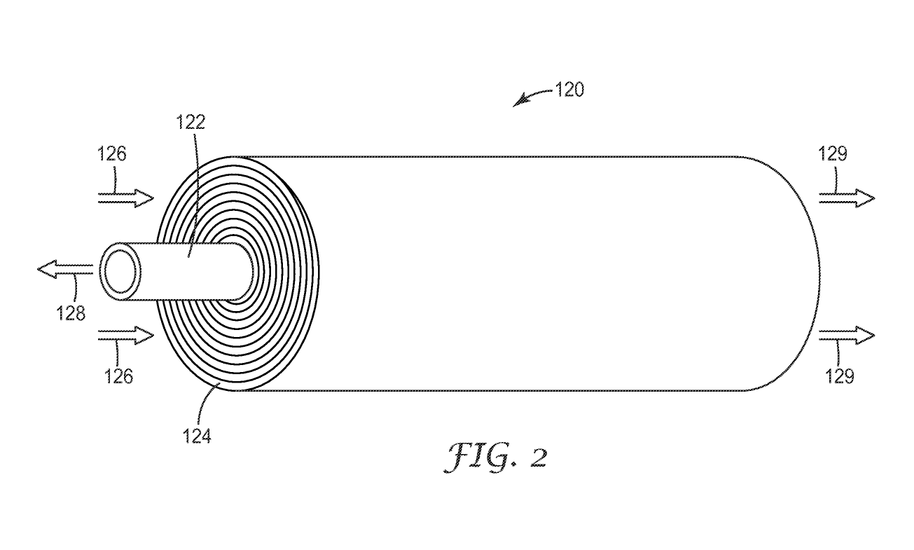

FIG. 2 is an illustration of an exemplary module 120 (specifically, a spiral-wound module) that includes a support tube 122, an exemplary composite membrane construction 124 of the present disclosure wound onto the support tube 122. During use, a mixture of liquids to be separated (e.g., alcohol and gasoline mixture) enters the module 120 and flows along the direction of arrows 126 into the composite membrane construction 124. Exemplary gasoline is not substantially absorbed by the pore-filling polymer of the asymmetric composite membrane of the composite membrane construction 124 (when the desired flux and selectivity of the system are obtained), while the more permeable liquid (e.g., alcohol) is absorbed in and passes through the pore-filling polymer and then flows out of the center of the support tube 122 along the direction of arrow 128. For example, a high concentration of alcohol (typically with a small amount of gasoline), which is separated from an alcohol/gasoline mixture, flows out of the center of the support tube 122 as vapor and/or liquid along the direction of arrow 128 (i.e., the permeate), and the resultant mixture with a lower concentration of alcohol than present in the mixture that enters the composite membrane flows out of the composite membrane along the direction of arrows 129 (i.e., the retentate).

In certain embodiments, an exemplary separation module (i.e., cartridge) has a volume in the range of from 200 milliliters (mL) up to and including 5.000 liters (I.). In accordance with the present disclosure, the volume of the separation module may include, in increments of 10 mL, any range between 200 mL and 5.000 L. For example, the separation module volume may be in the range of from 510 mL up to 4.990 L, or 600 mL up to 5.000 L, or 1.000 L up to 3.000 L, etc. In certain embodiments, the separation module has a volume of 1.000 L.

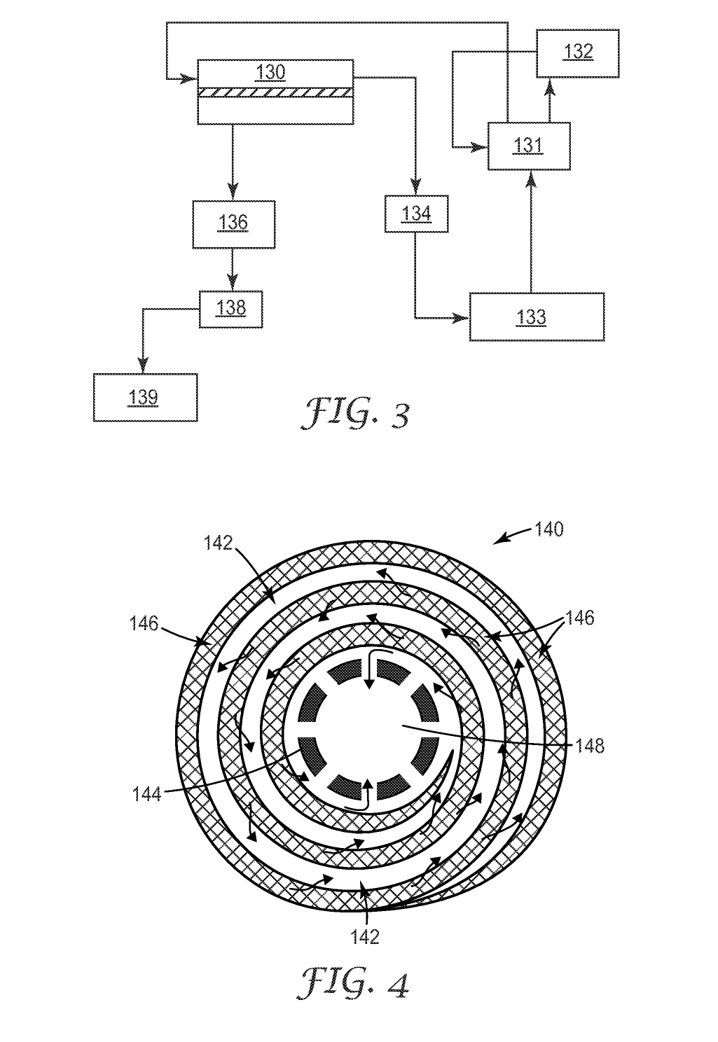

Separation modules that include asymmetric composite membranes of the present disclosure may be incorporated into fuel separation systems, which may be used in, or in conjunction with, engines such as flex-fuel engines. An exemplary fuel separation system is shown in FIG. 3, which employs a membrane pervaporation method (PV method) to separate high ethanol fraction gasoline from gasoline containing ethanol. Typically, gasoline is introduced into an inlet of a membrane separation unit 130 after being passed through a heat exchanger 131 (which is connected to engine coolant 132) from a main fuel storage tank 133. A low-ethanol fraction fuel from the membrane separation unit 130 is returned to the main fuel storage tank 133 after being cooled as it passes through a radiator 134. The ethanol-rich vapor which came out of membrane separation unit 130 is typically passed through a condenser 136 where it is condensed under negative pressure produced by vacuum pump 138 and then collected in an ethanol tank 139.

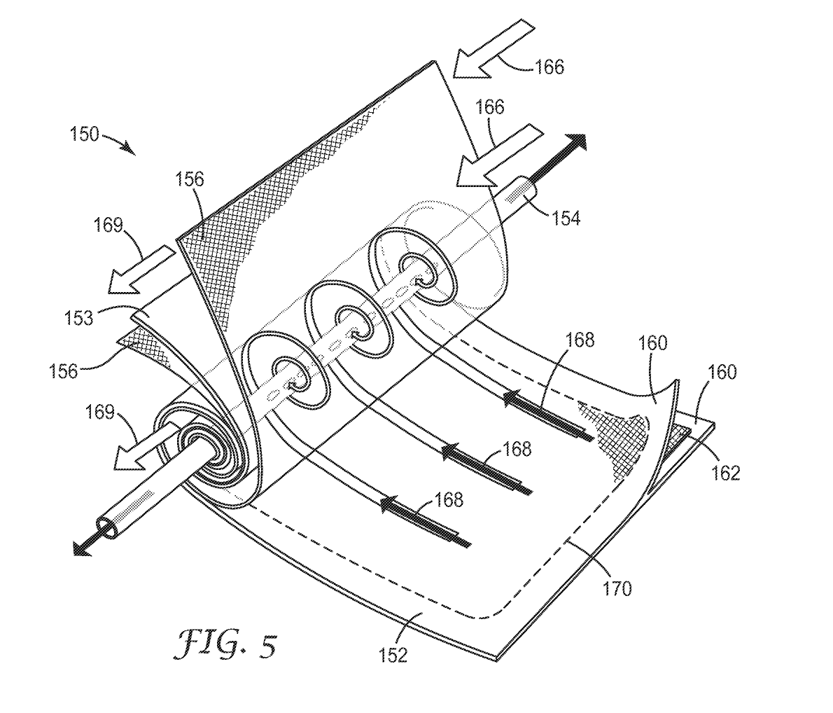

In one exemplary embodiment, the cross-section of a single-leaf spiral-wound separation module 140 is shown in FIG. 4. One separation leaf 142 is shown in cross-section (that includes first and second asymmetric composite membranes and a permeate mesh spacer sandwiched therebetween that forms a “membrane envelope”) and is shown wound spirally around a support tube (e.g., a perforated permeate collection tube) 144 along with a feed spacer 146. The arrows indicate the permeate flow from the feed spacer 146 into permeate spacer of separation leaf 142 and then into the lumen 148 of the support tube 144.

Suitable feed spacers (146 in FIG. 4) include materials that do not swell significantly in the fluids (e.g., gasoline and ethanol) that contact it, particularly at elevated temperatures. Such significant swelling is detrimental to the operation of the module as the swollen spacer could then block the feed spacer channels. Examples of suitable feed spacers include polymeric materials such as polyester nonwoven material available under the trade name LD7240 from Midwest Filtration LLC, Cincinnati, Ohio, polyester tricot textile material available under the trade name Guilford Prod. No. 45214 from Guilford Textile Co., Wilmington, N.C., extruded square nylon mesh available under the trade name NN1500 from Industrial Netting, Minneapolis, Minn., extruded nylon diamond mesh available under the trade name NN3100 from Industrial Netting, polyester woven mesh available under the trade names WS0200 and WS0300 from Industrial Netting, polyphenylene sulfide extruded mesh available under the trade name PPS #P861 (or NALTEX N01328_60PPS-NAT) from Delstar Technologies, Inc., Middletown, Del.

In another exemplary embodiment, an exploded view of a multi-leaf spiral-wound separation module 150 is shown in FIG. 5. Two separation leafs 152 and 153 are shown wound spirally around a support tube (e.g., a perforated permeate collection tube) 154 along with a feed spacer 156 (two shown). Each separation leaf 152 and 153 includes first and second portions of an asymmetric composite membrane 160 with a permeate mesh spacer 162 sandwiched therebetween forming a “membrane envelope.” During use, a fluid mixture, e.g., a mixture of liquids, to be separated (e.g., alcohol and gasoline mixture) enters the module 150 and flows along the direction of arrows 166 into the composite membrane construction that includes the separation leafs 152 and 153 spirally wound with feed spacer(s) 156. Exemplary gasoline is not absorbed by the pore-filling polymer of the asymmetric composite membrane of the asymmetric composite membrane 160, while the more permeable liquid (e.g., alcohol) is absorbed in and passes through the pore-filling polymer and then flows out of the center of the support tube 154 along the direction of solid arrows 168. For example, a high concentration of alcohol (typically with a small amount of gasoline), which is separated from an alcohol/gasoline mixture, flows out of the center of the support tube 154 as vapor and/or liquid along the direction of the solid arrows (i.e., the permeate), and the resultant mixture with a lower concentration of alcohol than present in the mixture that enters the composite membrane flows out of the composite membrane along the direction of arrow 169 (i.e., the retentate). The edge-seal bond is shown along dashed line 170. If a folded edge is present, it may also have an edge-seal bond.

### Permeate Mesh Spacers of the Separation Modules

As discussed above, a separation module includes at least one separation leaf that includes first and second asymmetric composite membranes and a permeate mesh spacer sandwiched therebetween using an edge-seal bond that adheres the first and second asymmetric composite membranes and permeate spacer together, thereby forming a “membrane envelope.”

The permeate spacer provides an open pathway for permeate removal from the membrane surface. The permeate spacer can include one or more layers of mesh. These layers may be the same or different (i.e., of the same or different materials having the same or different aperture sizes). Each mesh layer is made of strands that are parallel to the direction of vapor flow and strands that are non-parallel (i.e., perpendicular or oblique) to the direction of vapor flow, thereby forming flow channels and openings.

The opening sizes of the different mesh layers can be the same or different. In certain embodiments, a large mesh layer has large mesh openings with an average aperture size of 0.03 inch to 0.30 inch (0.76 mm to 7.6 mm) with an open area of 50% to 90%. In certain embodiments, a small mesh layer has small mesh openings with an average aperture size of 0.001 inch to 0.03 inch (0.0254 mm to 0.762 mm) with an open area of 5% to 50%.

The size of the flow channels of the large mesh layer may be more influential on the process than the opening size. For example, in certain embodiments it is preferred that mesh strands parallel to the direction of vapor flow are larger in size (e.g., diameter) than the mesh strands non-parallel (i.e., perpendicular or oblique) to the direction of vapor flow. It should be noted that it is possible for the mesh strands to be at different angles with each other within any one layer, as long as the larger strands are in the vapor flow direction. The larger the strand size difference, the lower the vapor transport resistance or the lower the pressure drop at the same mesh thickness.

Also, the size of the flow channels between two mesh layers may be affected by the relative orientation of the strands parallel to the direction of vapor flow and those strands non-parallel (i.e., perpendicular or oblique) to such parallel strands in one such layer. For example, for two large mesh layers, if the parallel strands are in the same plane as the non-parallel strands (the latter of which are smaller in diameter than the parallel strands), the flow channel height will be different than if the larger diameter parallel strands and the smaller diameter non-parallel strands are stacked (i.e., not in the same plane). In the latter situation, the channel height would be equal to the diameter of the larger strand, whereas in the former situation, the channel height would be equal to the difference between the diameters of the larger diameter parallel strands and the smaller diameter non-parallel strands.

In certain embodiments, a permeate spacer can include at least one large mesh layer and/or at least one small mesh layer. In one embodiment, a permeate spacer can include first and second large mesh layers and a small mesh layer sandwiched between the first and second large mesh layers. In another embodiment, a permeate spacer can include first and second small mesh layers and a large mesh layer sandwiched between the first and second small mesh layers. In alternative embodiments, a permeate spacer can include two large mesh layers, or a small and a large mesh layer, or other suitable combinations of mesh layers.

A small mesh opening prevents membrane intrusion and embossing so that membrane shape is not changed. A rigid small mesh layer (i.e., one with greater stiffness) prevents the intrusion of space between strands in a coarse mesh layer. That is, a rigid or stiff small mesh layer is desirable as it can provide support to eliminate or reduce membrane or small mesh layer intrusion into a coarse mesh (i.e., large mesh) layer, thereby reducing permeate pressure drop. In certain embodiments, a small mesh layer may have a rigidity that is greater than that of the asymmetric composite membrane.

Permeate spacer materials can include, for example, organic polymeric materials such as polyester, polysulfone, polyethersulfone, nylon, fluorinated polymers such as polyvinylidine difluoride and polytetrafluoroethylene, epoxy-coated materials, phenolic resin coated materials, polyphenylene sulfide, polyimide, polyether such as polyetheretherketone, as well as inorganic materials such as fiberglass, stainless steel, aluminum, or other metals. Various combinations of such materials can be used in the permeate spacer.

Commercially available examples of permeate spacer mesh layers include, for example, coarse meshes, such as PBT #P864 (or NALTEX N02413/19_45PBTNAT) polybutylene terephthalate asymmetrical extruded mesh from Delstar Technologies, Inc. and NN1000 extruded square nylon mesh from Industrial Netting Co., Minneapolis, Minn.; small meshes, such as WS0200, WS0300, and WS0800 polyester woven meshes, and NN1500 extruded square nylon mesh, all from Industrial Netting Co., and tricot textile materials, such as Guilford #45214 from Guilford Textile Co., Wilmington, N.C.

The permeate spacer materials could be in the form of woven materials, extruded netting or mesh, corrugated materials, and the like. A particular example of a permeate spacer includes one in the form of spaced-apart filaments disposed on a thin solid film, wherein the filaments align with the permeate vapor-flow direction into the collection tube.

In certain embodiments, the thickness of a total permeate spacer (i.e., in one or more layers) is at least 0.254 mm, and in certain embodiments at least 0.508 mm. In certain embodiments, the thickness of a total permeate spacer (i.e., in one or more layers) may be up to 10.2 mm. With this upper limit, a module with other parts the same has 0.12 m² membrane area/0.86 L module, or a module size of over 5 L, if a membrane packing density of 1 m²/liter is reached. Permeate spacers may have a non-uniform thickness in the direction of permeate flow pathway. For example, the permeate spacer could be thicker close to the permeate collection tube.

### Edge-Seal Bonds of the Separation Modules

The edge-seal bond includes a pore-filling sealant within at least a portion of the pores of the first and second asymmetric composite membranes, and an adhesive within at least a portion of the mesh openings of the permeate spacer. In certain embodiments, the pore-filling sealant is distinct from the adhesive. In certain embodiments, the pore-filling sealant and the adhesive are the same before application, but they are applied under different conditions (e.g., different temperatures) such that they have different viscosities. Typically, such differing viscosities during application will result in distinct materials in the final product (e.g., different molecular weight distribution, different chemical structure, and different filler content).

Preferably, the pore-filling sealant and the adhesive of the edge-seal bond do not swell in the presence of a fluid (typically, a liquid) to be filtered under separation conditions. Typical conditions used in separation methods of the present disclosure include fuel temperatures of from room temperature up to 95° C., fuel pressures of from 10 pounds per square inch (psi) to 100 psi, fuel flow rates of 0.1 liter per minute (L/min) to 20 L/min, and vacuum pressures of from 20 Torr to ambient pressure (i.e., 760 Torr). The fluid against which the pore-filling sealant and the adhesive of the edge-seal bond are tested to determine swellability cart be a gas or a liquid. It can be the retentate (i.e., the residue of the fluid after the separation, such as the depleted fuel, e.g., low octane fuel, that flows out of the separation module) or the permeate (i.e., the enriched portion of the fluid). It is preferably a liquid such as an alcohol/gasoline mixture. A material that “does not swell” refers to a material (whether it serves the purpose of a pore-filling sealant or an adhesive) that passes the Swelling Test as described in the Examples Section.

In certain embodiments, the adhesive fills the large mesh openings of the at least one large mesh layer of the permeate spacer within the edge-seal bond. In certain embodiments, the pore-filling sealant and/or the adhesive fills the small mesh openings of the at least one small mesh layer of the permeate spacer within the edge-seal bond.

In certain embodiments, the pore-filling sealant fills the pores of the microporous layer (e.g., layer 14 shown in FIG. 1A) of the porous substrate of the asymmetric composite membrane within the edge-seal bond. In certain embodiments, the pore-filling sealant fills the pores of the microporous layer and at least a portion of the macroporous layer (e.g., layer 16 shown in FIG. 1A) of the porous substrate of the asymmetric composite membrane within the edge-seal bond. In certain embodiments, the pore-filling sealant may also have a viscosity sufficient to fill at least a portion of the pores of the nanoporous layer (e.g., layer 12 shown in FIG. 1A) of the porous substrate of the asymmetric composite membrane within the edge-seal bond. In certain embodiments, the pore-filling sealant and/or the adhesive fills the pores of the macroporous layer of the porous substrate of the asymmetric composite membrane within the edge-sealing bond.

The pore-filling sealant has a relatively low viscosity during application to allow it to impregnate into at least micro-pores (and possibly even the nano-pores) of an asymmetric composite membrane. In certain embodiments, the pore-filling sealant is of a viscosity (during application) sufficient to wick into at least a portion of the pores of the asymmetric composite membrane, and preferably to fill the pores of the microporous layer, optionally at least a portion of the pores of the nanoporous layer, and even the macroporous layer of the porous substrate of the asymmetric composite membrane within the edge-sealing bond (such that the pore filling sealant is sufficiently close to the selective layer such that all fine pores that could cause micro-leaking are sealed). In certain embodiments, the pore-filling sealant has a viscosity of less than 20,000 centipoise (cP).

The adhesive has a relatively high viscosity during application to allow it to impregnate the permeate spacer without penetrating into the micro- or nano-pores of the asymmetric composite membrane (although some penetration into the macro-pores of the asymmetric composite membrane may be acceptable). In certain embodiments, the adhesive is of a viscosity (during application) sufficient to fill the large mesh openings of the large mesh layer of the permeate spacer within the edge-seal bond, and to avoid sagging and interfering in the flow path. In certain embodiments, the adhesive has a viscosity of at least 20,000 cP.

Upon curing, both the pore-filling sealant and the adhesive within the edge-seal bond are of a sufficient flexibility to allow manipulation of the asymmetric composite membrane bonded to the premeate spacer without cracking or breakage of the bond. In certain embodiments, the adhesive Tg (glass transition temperature) is greater than the use temperature.

In certain embodiments, a suitable pore-filling sealant and adhesive combination is one that is characterized by a wicking time of greater than 10 hours, or greater than 18 hours, according to the Wicking Test as described in the Examples Section.

In certain embodiments, a suitable pore-filling sealant and adhesive combination is one that passes the Module Pressure Integrity Test as described in the Examples Section.

In certain embodiments, a suitable pore-filling sealant and adhesive combination is one that is characterized by a vacuum of less than 6 kPa, or less than 3 kPa, or less than 1.5 kPa, according to the Module Vacuum Integrity Test as described in the Examples Section.

The pore-filling sealant and the adhesive may include the same or different materials. That is, they may include the same or different compositions, including, for example, resins, curing agents, toughening agents, accelerators/catalysts, fillers, and the like, as well as combinations thereof.

Exemplary pore-filling sealants and/or the adhesives may be prepared from conventional structural adhesives. Structural adhesives may be one-part adhesives and two-part adhesives. With a one-part adhesive, a single composition includes all the materials necessary to obtain a final cured adhesive. Such adhesives are typically applied to the substrates to be bonded and exposed to elevated temperatures (e.g., temperatures greater than 50° C.) to cure the adhesive. In contrast, two-part adhesives include two components. The first component, typically referred to as the “base resin component,” includes the curable resin, e.g., a curable epoxy resin. The second component, typically referred to as the “accelerator component,” includes the curing agent(s) and catalysts. Various other additives may be included in one or both components.

In certain embodiments, the pore-filling sealant and/or adhesive may include an epoxy adhesive, e.g., an epoxy structural adhesive, as described, for example, in International Publication Nos. WO 2013/151835 (Braendli et al.) and WO 2012/021258 (Kropp), as well as U.S. Pat. No. 8,729,197 (Kropp).

In certain embodiments, the pore-filling sealant and/or adhesive may include polythioethers and polysulfides, such as those described, for example, in U.S. Pat. No. 7,645,840 (Zook et al.), U.S. Pat. No. 6,800,371 (Gross), and U.S. Pat. No. 4,366,307 (Singh et al.).

In certain embodiments, the pore-filling sealant and/or adhesive of the edge-sealing bond of the separation modules of the present disclosure may include a hybrid of an epoxy and a polysulfide.

Suitable epoxy resins for use in the pore-filling sealant and/or adhesive of the edge-sealing bond of the separation modules of the present disclosure include those having the general Formula I:

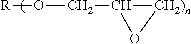

wherein: R includes one or more aliphatic groups, cycloaliphatic groups, and/or aromatic hydrocarbon groups, optionally wherein R further includes at least one ether linkage between adjacent hydrocarbon groups; R has a molecular weight at least 14 and no greater than 9854, and n is an integer greater than 1. Generally, n is the number of glycidyl ether groups and must be greater than 1 for at least one of the first epoxy resins of Formula I present in the adhesive. In some embodiments, n is 2 to 4, inclusive. Exemplary first epoxy resins include glycidyl ethers of bisphenol A, bisphenol F, and novolac resins as well as glycidyl ethers of aliphatic or cycloaliphatic diols. Examples of commercially available glycidyl ethers include diglycidylethers of bisphenol A (e.g. those available under the trade names EPON 828, EPON 1001, EPON 1310 and EPON 1510 from Hexion Specialty Chemicals GmbH, Rosbach, Germany, those available under the trade name D.E.R. from Dow Chemical Co. (e.g., D.E.R. 331, 332, and 334), those available under the trade name EPICLON from Dainippon Ink and Chemicals, Inc. (e.g., EPICLON 840 and 850) and those available under the trade name YL-980 from Japan Epoxy Resins Co., Ltd.); diglycidyl ethers of bisphenol F (e.g. those available under the trade name EPICLON from Dainippon Ink and Chemicals, Inc. (e.g., EPICLON 830)); polyglycidyl ethers of novolac resins (e.g., novolac epoxy resins, such as those available under the trade name D.E.N., from Dow Chemical Co. (e.g., D.E.N. 425, 431, and 438)); and flame retardant epoxy resins (e.g., D.E.R. 580, a brominated bisphenol type epoxy resin available from Dow Chemical Co.). In some embodiments, aromatic glycidyl ethers, such as those prepared by reacting a dihydric phenol with an excess of epichlorohydrin, may be preferred.

Generally, the epoxy resin component may include additional epoxy resins, including, but not limited to, two or more first epoxy resins and/or two or more second epoxy resins. In some embodiments, the epoxy resins component includes a third epoxy resin, wherein the third epoxy resin includes at least one epoxy-based reactive diluent.

In some embodiments, a first epoxy resin has a molecular weight of at least 170, e.g., at least 200 grams/mole (g/mol). In some embodiments, a first epoxy resin has a molecular weight of no greater than 10,000, e.g., no greater than 3,000 g/mol. In some embodiments, the epoxy equivalent weight of the first epoxy resin is at least 50, in some embodiments, at least 100 g/mol of epoxy equivalents. In some embodiments, the epoxy equivalent weight of the first epoxy resin is no greater than 500 g/mol, in some embodiments, no greater than 400 g/mol of epoxy equivalents.

Epoxy-based reactive diluents, including mono-epoxy compounds and di/poly-functional epoxy compounds, may be added to, e.g., reduce viscosity and improve wetting. The presence of the epoxide group(s) allows the reactive diluent to participate, with the other epoxy resin components and curing agents, in polymerization and crosslinking, thus allowing the diluent to be co-reacted into the resultant crosslinked network. Suitable diluents can have at least one reactive terminal end portion and, preferably, a saturated or unsaturated cyclic backbone. Exemplary reactive terminal ether portions include glycidyl ether. Commercially available epoxy-based reactive diluents useful in the present disclosure as third epoxy resins include purified p-t-butyl glycidylphenol (available under the trade name, EP 509S, from Adeka, Co.), 1,4-butanediol diglycidyl ether (available under the trade name, ERISYS GE21, from CVC; and available under the trade name, RD-2, from Ciba Product Corp.), hexanediol diglycidyl ether (available under the trade name, YED 216, from Japan Epoxy Resins, Ltd.), divinylbenzene dioxide, allocimene dioxide, monovinyl cyclohexane oxide, epoxypentyl ethers, epoxidized cyclohexenyl compounds, limonene diepoxide, bis(2,3-epoxy-2-methyl propyl)ether, 2,3-epoxy-2-methyl propyl ethers of alkylene glycols, 1,2-bis(epoxyalkyl)cyclobutanes, glycidyl glycidate, 3,4-epoxyhexahydrobenzyl glycidyl ether, glycidyl ethers of C7-C9 alcohols, oxymethyl-1,3-diozalane glycidyl ether, allyl glycidyl ether, butyl glycidyl ether, phenyl glycidyl ether, styrene oxide, and octylene oxide. In some embodiments, the epoxy-based reactive diluent shows a high affinity for one or more plastic substrates as determined by swelling or dissolution of the plastic substrate left in contact with the epoxy-based reactive diluent for 6.5 hours or less. In some embodiments, the epoxy-based reactive diluent shows a high affinity for one or more plastic substrates as determined by swelling or dissolution of the plastic substrate left in contact with the epoxy-based reactive diluent for an amount of time between about 5 hours and about 6.5 hours. Exemplary plastic substrates include PC (polycarbonate), polyamides, polyesters, polyolefins, polysulfones, fluoropolymers, as well as combinations thereof. In some embodiments, the addition of the epoxy-based reactive diluent may improve the bond strength of the adhesive to certain plastic substrates.

In some embodiments, the compositions of the pore-filling sealants and/or adhesives for use in making the edge-sealing bonds of the separation modules of the present disclosure include at least 20 wt-%, e.g., at least 25 wt-%, or even at least 30 wt-%, of the epoxy resin component, based on the total weight of the composition. In some embodiments, the compositions of the present disclosure include no greater than 90 wt-%, e.g., no greater than 75 wt-%, or even no greater than 60 wt-% of the epoxy component resin, based on the total weight of the composition.

The compositions of the pore-filling sealants and/or adhesives for use in making the edge-sealing bonds of the separation modules of the present disclosure may also include one or more curing agents. Suitable curing agents are compounds which are capable of cross-linking the epoxy resin. Typically, these agents are primary and/or secondary amines. The amines may be aliphatic, cycloaliphatic, or aromatic. In some embodiments, useful amine curing agents include those having the general Formula (II):

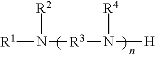

wherein: R¹, R², and R⁴ are independently selected from hydrogen, a hydrocarbon containing 1 to 15 carbon atoms, and a polyether containing up to 15 carbon atoms; R³ represents a hydrocarbon containing 1 to 15 carbon atoms or a polyether containing up to 15 carbon atoms; and n is from 2 to 10, inclusive.

The compositions of the pore-filling sealants and/or adhesives for use in making the edge-sealing bonds of the separation modules of the present disclosure may include at least two amine curing agents. One amine curing agent is a low equivalent weight amine curing agent, i.e., an amine curing agent having an amine equivalent weight of no greater than 45 grams per mole of amine equivalents. In some embodiments, the low equivalent weight amine curing agent has an amine equivalent weight of no greater than 40, or even no greater than 35 grams per mole of amine equivalents. In some embodiments, two or more low equivalent weight amine curing agents may be used.

The second amine curing agent is a high equivalent weight amine curing agent (amine prepolymer having at least two amine groups), i.e., an amine curing agent having an amine equivalent weight of at least 50 grams per mole of equivalents. In some embodiments, the high equivalent weight amine curing agent has an amine equivalent weight of at least 55 grains per mole of amine equivalents. In some embodiments, two or more high equivalent weight amine curing agents may be used.

Exemplary amine curing agents include ethylene amine, ethylene diamine, diethylene diamine, propylene diamine, hexamethylene diamine, 2-methyl-1,5-pentamethylene-diamine, triethylene tetramine (“TETA”), tetraethylene pentamine (“TEPA”), hexaethylene heptamine, and the like. Commercially available amine curing agents include those available from Air Products and Chemicals, Inc. under the trade name ANC AMINE. At least one of the amine curing agents is a polyether amine having one or more amine moieties, including those polyether amines that can be derived from polypropylene oxide or polyethylene oxide. Suitable polyether amines that can be used include those available from Huntsman under the trade name JEFFAMINE, and from Air Products and Chemicals, Inc. under the trade name ANCAMINE. Suitable commercially available polyetheramines include those sold by Huntsman under the JEFFAMINE trade name. Suitable polyether diamines include JEFFAMINEs in the D, ED, and DR series. These include JEFFAMINE D-230, D-400, D-2000, D-4000, HK-511, ED-600, ED-900, ED-2003, EDR-148, and EDR-176. Suitable polyether triamines include JEFFAMINEs in the T series. These include JEFFAMINE T-403, T-3000, and T-5000. Polyether triamines are preferred, and polyether triamine of molecular weight about 5000 (e.g., JEFFAMINE T-5000) is most preferred.

In some embodiments, the relative amounts of the low and high equivalent weight amine curing agents are selected such that the low equivalent weight amine curing agent(s) compose at least 25 wt-%, in some embodiments, at least 30 wt-%, at least 40 wt-%, or even at least 50 wt-%, of the combined weight of the low and high equivalent weight amine curing agents. In some embodiments, the low equivalent weight amine curing agent(s) compose between 30 wt-% and 70 wt-%, in some embodiments, between 30 wt-% and 60 wt-%, or even between 30 wt-% and 50 wt-%, of the combined weight of the low and high equivalent weight amine curing agents.

The compositions of the pore-filling sealants and/or adhesives for use in making the edge-sealing bonds of the separation modules of the present disclosure may include one or more toughening agents. Toughening agents are polymers capable of increasing the toughness of cured epoxy resins. The toughness can be measured by the peel strength of the cured compositions. Typical toughening agents include core/shell polymers, butadiene-nitrile rubbers, and acrylic polymers and copolymers, for example, methyl methacrylate-butadiene-styrene polymer. The toughening agent may be a core/shell polymer. Generally, the shell comprises one or more polymers grafted on to the core. In some embodiments, the shell polymer has a high glass transition temperature, i.e., a glass transition temperature greater than 26° C. The glass transition temperature may be determined by dynamic mechanical thermo analysis. Exemplary core/shell polymers and their preparation are described in, e.g., U.S. Pat. No. 4,778,851 (Henton et al.). Commercially available core/shell polymers include, e.g., PARALOID EXL 2600 from Rohm & Haas Company, Philadelphia, Pa., and KANE ACE MX 120 from Kaneka. Belgium. The core/shell polymer has an average particle size of at least 10 nm, e.g., at least 150 nm. In some embodiments, the core/shell polymer has an average particle size of no greater than 1,000 nm, e.g., no greater than 500 nm. The core/shell polymer may be present in an amount of at least 5 wt-%. e.g., at least 7 wt-%, based on the weight of the total composition. In some embodiments, the core/shell polymer may be present in an amount no greater than 50 wt-%, e.g., no greater than 30 wt-%, e.g., no greater than 15 wt-%, based on the weight of the total composition.

Most amine-cured room temperature curing epoxy-based adhesives are relatively slow curing and can take several hours to reach handling strength. Catalysts, typically tertiary amines, phenol functional resins, and some metal salts can accelerate these cures.

In some embodiments, compositions of the pore-filling sealants and/or adhesives for use in making the edge-sealing bonds of the separation modules of the present disclosure may also include a secondary catalyst. Exemplary secondary catalysts include imidazoles, imidazole-salts, and imidazolines. Aromatic tertiary amines may also be used as secondary curatives, including those having the structure of Formula (IV):

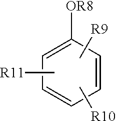

wherein; R⁸ is H or an alkyl group; R⁹, R¹⁰, and R¹¹ are, independently, hydrogen or CHNR¹²R¹³, wherein at least one of R⁹, R¹⁰, and R¹¹ is CHNR¹²R¹³; and R¹² and R¹³ are, independently, alkyl groups. In some embodiments, the alkyl groups of R⁸, R¹², and/or R¹³ are methyl or ethyl groups. One, exemplary secondary curative is tris-2,4,6-(dimethylaminomethyl)phenol, commercially available as ANCAMINE K54 from Air Products Chemicals.

Metal catalysts may also be included in epoxy resin compositions for use in the pore-filling sealants and/or adhesives used to make the edge-sealing bonds of the separation modules of the present disclosure. Suitable metal salt catalysts include the group I metal, group II metal, and lanthanoid salts. In some embodiments, the group I metal cation is lithium. In some embodiments, the group II metal cation is calcium or magnesium. Generally, the anion is selected from nitrates, iodides, thiocyanates, triflates, alkoxides, perchlorates, and sulfonates, including their hydrates. In some embodiments, the anion is a nitrate or a triflate. In some embodiments, the metal salt catalyst may be selected from the group consisting of lanthanum nitrate, lanthanum triflate, lithium iodide, lithium nitrate, calcium nitrate, calcium triflate, and their corresponding hydrates. In general, a catalytic amount of salt is employed. In some embodiments, the composition will include at least 0.1 wt-%, or at least 0.5 wt-%, or even at least 0.8 wt-%, catalyst, based on the total weight of the composition. In some embodiments, the composition will include no greater than 2 wt-%, or no greater than 1.5 wt-%, or even no greater than 1.1 wt-%, catalyst, based on the total weight of the composition. In some embodiments, the composition includes 0.2 wt-% to 2 wt-%, e.g., 0.3 wt-% to 1.5 wt-%, or even 0.8 wt-% to 1.1 wt-% catalyst, based on the total weight of the composition.

Multifunctional (meth)acrylates may be included in a two-part epoxy resin of the pore-filling sealants and/or adhesives for use in making the edge-sealing bonds of the separation modules of the present disclosure. Such multifunctional (meth)acrylates include compounds including two or more acrylate or methacrylate functional groups. The (meth)acrylates will react with amines in the accelerator component of a two-part epoxy system via the Michael reaction, which is a more rapid reaction than that of the epoxy with the amine. Exemplary multifunctional (meth)acrylates useful for shortening the gel time include hexanediol diacrylate; pentaerythritol pentaacrylate; blends of multifunctional acrylic resins available under the trade name M-CURE, from Sartomer; and trimethylol propane triacrylate (TMPTA), available, in various levels blended with bisphenol A epoxy resins, under the trade name, EPON 8111, from Hexion. In some embodiments, the multifunctional acrylate and the acetoacetoxy-functionalized compound, such as EASTMAN AAEM (Acetoacetoxyethyl Methacrylate), together comprise at least 11 wt-% of the adhesive. In some embodiments, the ratio of the multifunctional acrylate to the acetoacetoxy-functionalized compound ranges from 80 parts by weight multifunctional acrylate:20 parts by weight acetoacetoxy-functionalized compound to 20 parts by weight multifunctional acrylate:80 parts by weight acetoacetoxy-functionalized compound.

Pore-filling sealants and/or adhesives for use in making the edge-sealing bonds of the separation modules of the present disclosure may also include one or more fillers and/or pigments. Exemplary fillers include particles, microspheres, expendable microspheres, glass beads, glass microspheres, fibers, electrically and/or thermally conducting particles, nanoparticles, hydrophilic or hydrophilic silica type fillers such as silica-gels, fumed silica, clays such as bentonite or wollastonite, organo-clays, aluminium-trihydrates, hollow-polymeric microspheres, and mineral fillers such as calcium silicates, phosphates, molybdates, calcium carbonate, calcium oxide, and talc, and any combinations thereof. Pigments may include inorganic or organic pigments including ferric oxide, brick dust, carbon black, titanium oxide, and the like.

Pore-filling sealants and/or adhesives for use in making the edge-sealing bonds of the separation modules of the present disclosure may also include other additives such as adhesion promoters such as silane coupling agents, corrosion inhibitors, and rheology controlling agents.

### Methods of Making Separation Modules

Methods of making a separation module are provided. Generally, the method includes: applying a pore-filling sealant adjacent to at least one edge of each membrane, wherein the pore-filling sealant has a viscosity sufficient to fill at least a portion of the pores of the membrane; applying an adhesive adjacent to at least one edge of the permeate spacer, wherein the adhesive has a viscosity sufficient to fill at least a portion of the mesh openings of the permeate spacer; and forming an edge-seal bond between the pore-filling sealant and adhesive that adheres the first and second asymmetric composite membranes and permeate spacer together, wherein the pore-filling sealant viscosity is lower than the adhesive viscosity when applied.

In certain embodiments of the method, the pore-filling sealant and the adhesive are applied at different temperatures. In certain embodiments, the pore-filling sealant and adhesive are distinct compositions. In certain embodiments, at least one of the pore-filling sealant and adhesive includes one or more fillers, as discussed above.

In certain embodiments of the method, the asymmetric composite membranes include: a porous substrate comprising opposite first and second major surfaces, and a plurality of pores; and a pore-filling polymer disposed in at least some of the pores so as to form a layer having a thickness within the porous substrate, with the amount of the polymer at or adjacent to the first major surface being greater than the amount of the polymer at or adjacent to the second major surface. In certain embodiments, the porous substrate of each asymmetric composite membrane includes a nanoporous layer, a macroporous layer, and a microporous layer sandwiched between the nanoporous layer and the macroporous layer, wherein the macroporous layer of each membrane is positioned adjacent to the permeate spacer. With such constructions, applying a pore-filling sealant adjacent to at least one edge of each membrane includes applying the pore-filling sealant adjacent to at least one edge of the macroporous layer under conditions effective for the pore-filling sealant to fill the pores of the microporous layer and optionally at least a portion of the pores of the nanoporous layer within the edge-seal bond (such that the pore filling sealant is sufficiently close to the selective layer such that all fine pores that could cause micro-leaking are sealed). Furthermore, with such constructions, applying an adhesive to at least one edge of the permeate spacer includes applying an adhesive to at least one edge of the permeate spacer under conditions effective for the adhesive to fill the large mesh openings of the large mesh layer within the edge-seal bond.

In certain embodiments of the method, applying a pore-filling sealant to at least one edge of each membrane further includes curing the pore-filling sealant.

In certain embodiments of the method, applying an adhesive to at least one edge of the permeate spacer includes applying the adhesive to at least one membrane having a pore-filling sealant applied thereto, and contacting at least a portion of the permeate spacer with the adhesive disposed on the membrane.

Thus, in methods of the present disclosure, the pore-filling sealant may be applied to an asymmetric composite membrane and be in an uncured state, partially cured state, or fully cured state when it comes into contact with the adhesive.

After the edge-seal bond is formed, the membrane envelope may be trimmed to remove membrane and/or permeate spacer on the outer perimeter of the bond. The feed spacer may be blocked by excessive adhesive at the edges of a module. Trimming may be done to expose the feed spacer at the edges of two ends of a module to allow the fuel to flow in and out of the module.

### Uses

Separation modules of the present disclosure may be used in various separation methods, including pervaporation, vapor permeation, gas separation, nanofiltration and organic solvent nanofiltration. The separation modules of the present disclosure are particularly useful in pervaporation methods. Pervaporation may be used for desulfurization of gasoline, dehydration of organic solvents, isolation of aroma components, and removal of volatile organic compounds from aqueous solutions.

Preferred methods of the present disclosure involve use of the separation modules in pervaporation, particularly pervaporating alcohol from an alcohol and gasoline mixture.

Well-known separation techniques may be used with the separation modules of the present disclosure. For example, nanofiltration techniques are described in U.S. Pat. Pub. No. 2013/0118983 (Livingston et al.), U.S. Pat. No. 7,247,370 (Childs et al.), and U.S. Pat. Pub. No. 2002/0161066 (Remigy et al.). Pervaporation techniques are described in U.S. Pat. No. 7,604,746 (Childs et al.) and EP 0811420 (Apostel et al.). Gas separation techniques are described in Journal of Membrane Sciences, vol. 186, pages 97-107 (2001).

Pervaporation separation rate is typically not constant during a depletion separation. The pervaporation rate is higher when the feed concentration of the selected material (e.g., ethanol) is higher than near the end of the separation when the feed concentration of the selected material is lower. This rate is typically not linear with concentration. At high feed concentration the separation rate is high and the feed concentration of the selected material and flux falls rapidly, but this concentration and flux changes very slowly as the limit of depletion is reached.

Typical conditions used in separation methods of the present disclosure include fuel temperatures of from room temperature up to 95° C., fuel pressures of from 10 pounds per square inch (psi) to 100 psi, fuel flow rates of 0.1 liter per minute (L/min) to 20 L/min, and vacuum pressures of from 20 Torr to ambient pressure (i.e., 760 Torr).

The performance of a separation module of the present disclosure in determined by: the properties of the pore-filling polymer anchored within the pores of the porous (support) membrane; sealing properties (major leaking, micro-leaking); effective membrane area (or packing density); effect of the feed spacer (e.g., turbulent effect, surface velocity); effect of the permeate spacer; operation conditions such as permeate vacuum pressure; and feed temperature.

### EXEMPLARY EMBODIMENTS

Embodiment 1 is a separation module comprising at least one separation leaf comprising: first and second asymmetric composite membranes having a permeate mesh spacer sandwiched between the first and second asymmetric composite membranes; and an edge-seal bond that adheres the first and second asymmetric composite membranes and permeate spacer together; wherein the first and second asymmetric composite membranes comprise pores and the permeate spacer comprise mesh openings; and wherein the edge-seal bond comprises: a pore-filling sealant within at least a portion of the pores of the first and second membranes; and an adhesive within at least a portion of the mesh openings of the permeate spacer; wherein the pore-filling sealant is distinct from the adhesive.

Embodiment 2 is the separation module of embodiment 1 wherein the pore-filling sealant and adhesive comprise different compositions.

Embodiment 3 is the separation module of embodiment 2 wherein the pore-filling sealant and adhesive have different viscosities when applied to form the edge-seal bond.

Embodiment 4 is the separation module of embodiment 2 or 3 wherein at least one of the pore-filling sealant composition and adhesive composition includes a filler.

Embodiment 5 is the separation module of any one of embodiments 2 through 4 wherein at least one of the pore-filling sealant composition and adhesive composition includes an adhesion promoter, a corrosion inhibitor, a rheology controlling agent, or a combination thereof

Embodiment 6 is the separation module of any one of embodiments 1 through 5 wherein the permeate spacer comprises at least one large mesh layer having large mesh openings.

Embodiment 7 is the separation module of embodiment 6 wherein the large mesh openings have an average aperture size of 0.03 inch to 0.30 inch (0.76 mm to 7.6 mm).

Embodiment 8 is the separation module of embodiment 6 or 7 wherein the permeate spacer further comprises at least one small mesh layer having small mesh openings.

Embodiment 9 is the separation module of embodiment 8 wherein the small mesh openings have an average aperture size of 0.001 inch to 0.03 inch (0.0254 mm to 0.762 mm).

Embodiment 10 is the separation module of embodiment 8 or 9 wherein the permeate spacer comprises first and second large mesh layers and the small mesh layer sandwiched between the first and second large mesh layers.

Embodiment 11 is the separation module of embodiment 8 or 9 wherein the permeate spacer comprises first and second small mesh layers and the large mesh layer sandwiched between the first and second small mesh layers.

Embodiment 12 is the separation module of any one of embodiments 1 through 11 wherein the premeate spacer is of a thickness of at least 0.254 mm.

Embodiment 13 is the separation module of any one of embodiments 6 through 12 wherein the adhesive fills the large mesh openings of the at least one large mesh layer of the permeate spacer within the edge-seal bond.

Embodiment 14 is the separation module of any one of embodiments 8 through 13 wherein the pore-filling sealant and/or the adhesive fills the small mesh openings of the at least one small mesh layer of the permeate spacer within the edge-seal bond.

Embodiment 15 is the separation module of any one of embodiments 1 through 14 which is a spiral-wound separation module, a plate and frame separation module, a tubular separation module, a hollow fiber separation module, or a pleated separation module.

Embodiment 16 is the separation module of any one of embodiments 1 through 15 wherein the asymmetric composite membranes selectively pervaporates alcohol from an alcohol and gasoline feed mixture.

Embodiment 17 is the separation module of any one of embodiments 1 through 16 wherein the pore-filling sealant and adhesive do not swell in the presence of a fluid to be filtered under separation conditions.

Embodiment 18 is the separation module of any one of embodiments 1 through 17 wherein the asymmetric composite membranes comprise: a porous substrate comprising opposite first and second major surfaces, and a plurality of pores; and a pore-filling polymer disposed in at least some of the pores so as to form a layer having a thickness within the porous substrate, with the amount of the polymer at or adjacent to the first major surface being greater than the amount of the polymer at or adjacent to the second major surface.

Embodiment 19 is the separation module of embodiment 18 wherein the porous substrate of each asymmetric composite membrane comprises a nanoporous layer, a macroporous layer, and a microporous layer sandwiched between the nanoporous layer and the macroporous layer, wherein the macroporous layer of each membrane is positioned adjacent to the permeate spacer.

Embodiment 20 is the separation module of embodiment 19 wherein the pore-filling sealant fills the pores of the microporous layer of the porous substrate of the asymmetric composite membrane within the edge-seal bond.

Embodiment 21 is the separation module of embodiment 19 or 20 wherein the pore-filling sealant and/or the adhesive fills the pores of the macroporous layer of the porous substrate of the asymmetric composite membrane within the edge-sealing bond.

Embodiment 22 is the separation module of any one of embodiments 1 through 21 wherein the pore-filling sealant and adhesive combination is one that is characterized by a wicking time of greater than 10 hours according to the Wicking Test in the Examples Section.

Embodiment 23 is the separation module of any one of embodiments 1 through 22 wherein the pore-filling sealant and adhesive combination is one that passes the Module Pressure Integrity Test as described in the Examples Section, and/or the pore-filling sealant and adhesive combination is one that is characterized by a vacuum of less than 6 kPa, or less than 3 kPa, or less than 1.5 kPa, according to the Module Vacuum Integrity Test as described in the Examples Section.

Embodiment 24 is the separation module of any one of embodiments 1 through 23 wherein the pore-filling sealant comprises an epoxy.

Embodiment 25 is the separation module of any one of embodiments 1 through 24 wherein the adhesive comprises an epoxy.

Embodiment 26 is a fuel separation system comprising the separation module of any one of embodiments 1 through 25.

Embodiment 27 is a method of separating ethanol from a mixture of ethanol and gasoline, the method comprising contacting the mixture with a separation module of any one of embodiments 1 to 25.

Embodiment 28 is a method of making a separation module comprising at least one separation leaf comprising first and second asymmetric composite membranes having a permeate spacer sandwiched between the first and second asymmetric composite membranes, wherein the first and second asymmetric composite membranes comprise pores and the permeate spacer comprises mesh openings; the method comprising: applying a pore-filling sealant adjacent to at least one edge of each membrane, wherein the pore-filling sealant has a viscosity sufficient to fill at least a portion of the pores of the membrane; applying an adhesive adjacent to at least one edge of the permeate spacer, wherein the adhesive has a viscosity sufficient to fill at least a portion of the mesh openings of the permeate spacer and forming an edge-seal bond between the pore-filling sealant and adhesive that adheres the first and second asymmetric composite membranes and permeate spacer together; wherein the pore-filling sealant viscosity is lower than the adhesive viscosity when applied.

Embodiment 29 is the method of embodiment 28 wherein the pore-filling sealant and the adhesive are applied at different temperatures.

Embodiment 30 is the method of embodiment 28 or 29 wherein the pore-filling sealant and adhesive are distinct compositions.

Embodiment 31 is the method of embodiment 30 wherein at least one of the pore-filling sealant and adhesive include a filler.

Embodiment 32 is the method of any one of embodiments 28 through 31 wherein the permeate spacer comprises at least one large mesh layer having large mesh openings.

Embodiment 33 is the method of embodiment 32 wherein the permeate spacer further comprises at least one small mesh layer having small mesh openings.

Embodiment 34 is the method of embodiment 33 wherein the permeate spacer comprises first and second small mesh layers and the large mesh layer sandwiched between the first and second small mesh layers.

Embodiment 35 is the method of any one of embodiments 28 through 34 wherein the asymmetric composite membranes comprise: a porous substrate comprising opposite first and second major surfaces, and a plurality of pores; and a pore-filling polymer disposed in at least some of the pores so as to form a layer having a thickness within the porous substrate, with the amount of the polymer at or adjacent to the first major surface being greater than the amount of the polymer at or adjacent to the second major surface.

Embodiment 36 is the method of embodiment 35 wherein the porous substrate of each asymmetric composite membrane comprises a nanoporous layer, a macroporous layer, and a microporous layer sandwiched between the nanoporous layer and the macroporous layer, wherein the macroporous layer of each membrane is positioned adjacent to the permeate spacer.

Embodiment 37 is the method of embodiment 36 wherein applying a pore-filling sealant adjacent to at least one edge of each membrane comprises applying the pore-filling sealant adjacent to at least one edge of the macroporous layer under conditions effective for the pore-filling sealant to fill the pores of the microporous layer and optionally at least a portion of the pores of the nanoporous layer within the edge-seal bond.

Embodiment 38 is the method of any one of embodiments 32 through 37 wherein applying an adhesive to at least one edge of the permeate spacer comprises applying an adhesive to at least one edge of the permeate spacer under conditions effective for the adhesive to fill the large mesh openings of the large mesh layer within the edge-seal bond.

Embodiment 39 is the method of any one of embodiments 28 through 38 wherein applying a pore-filling sealant to at least one edge of each membrane further comprises curing the pore-filling sealant.

Embodiment 40 is the method of any one of embodiments 28 through 39 wherein applying an adhesive to at least one edge of the permeate spacer comprises applying the adhesive to at least one membrane having a pore-filling sealant applied thereto, and contacting at least a portion of the permeate spacer with the adhesive disposed on the membrane.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

### Test Methods

### Swelling Test

One adhesive was applied onto a first aluminum plate and covered by a second plate. One silicone rubber was inserted between two plates to control the thickness of the adhesive (3 millimeter (mm)). The plates with adhesives were secured by clamps and cured in an oven at 90° C. for 30 minutes (min). The cured adhesives were separated from the plates and cut into 27-mm×27-mm samples. The adhesive samples were soaked in gasoline either at ambient temperature or at 70° C. Sample weight was monitored with time.

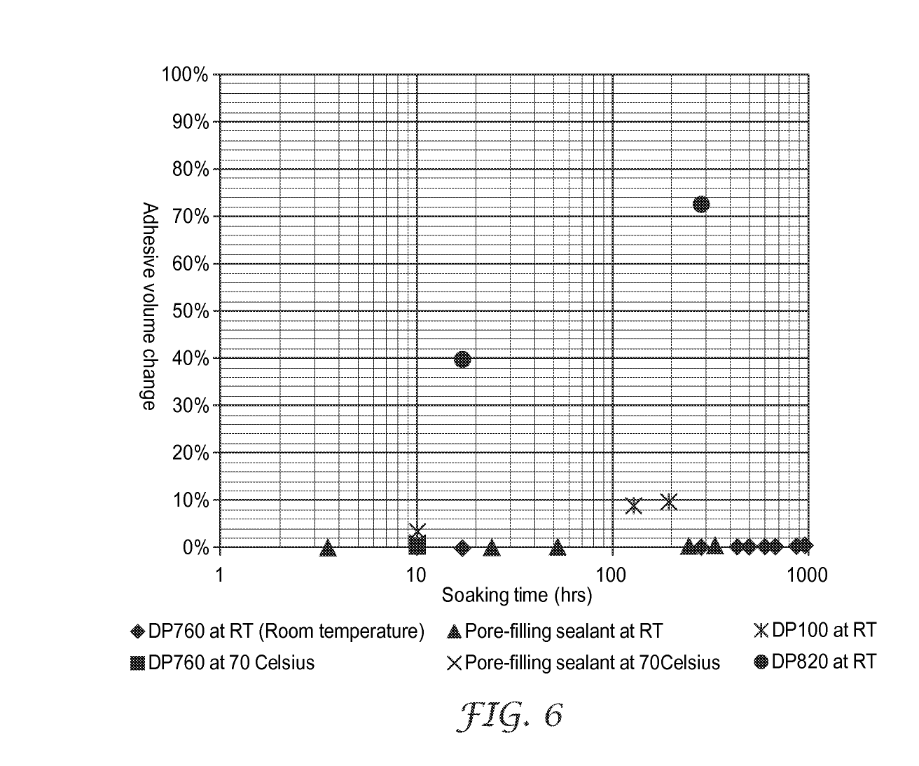

Two different adhesives were tested—DP820, a commercially available acrylic adhesive from 3M Company, and DP760 and DP100, commercially available epoxy adhesives from 3M Company, St. Paul, Minn. A pore-filling sealant was formulated by mixing 7 parts of EPON828 (Momentive Company, Columbus, Ohio) and 1 part of Triethylenetetramine “TETA” (Alfa Aesar, Heysham, England) and tested. As can be seen in FIG. 6, both DP760 adhesive and EPON828/TETA pore-filling sealant showed little swelling at room temperature, and even at elevated temperature.

### Wicking Test

Two 100-mm×100-mm membranes samples (Membrane 8) were cut and sandwiched together with the backing facing each other. Adhesives and pore-filling sealants were applied between two samples around the edges of three sides for sealing into a membrane envelope. The cured adhesives at the edges had about 10-mm width. After adhesives and pore-filling sealants were fully cured, one edge of the membrane envelope was dipped into a container with E10 gasoline. The gasoline liquid level was set to cover 5 mm of the dipped sealing edge. Wicking was considered to exist when the membranes beyond the sealing edge became transparent because of the soaked gasoline.

TABLE 1
Wicking Time of Sealant/Adhesive Combination

| Pore Sealant | Adhesive | Wicking Time (hours) |
|---|---|---|
| None | DP760 | 1.5 |
| EPON828/TETA | DP760 | >18 |
| EPON828/TTD | DP760 | >18 |
| DP100 | DP100 | >10 but <14.5 |

### Membrane Performance Test

The ability of the membranes to separate ethanol and gasoline from an ethanol/gasoline mixture was determined by the following technique. The membrane sample was mounted onto a stainless steel cell (Sepa CF II, obtained from General Electric Co., Fairfield, Conn.). The effective membrane surface area was 140 cm². Feedstock (1.1 liters) of E10 gasoline (10% ethanol, obtained from Marathon Oil Co., Houston, Tex.) was charged into the initial test vessel and heated by a heat exchanger and pumped through the membrane cell at a flow rate of 500 mL/min. The input and output temperatures of the feedstock at the inlet and outlet of the membrane cell were measured with thermometers and maintained at about 70° C. The permeate was collected in a cold trap cooled with liquid nitrogen every 5-10 minutes. The membrane cell vacuum was controlled by a regulator connected to a vacuum pump and maintained at 200 Torr. The average total mass flux was calculated based on the ethanol obtained from all the permeate samples collected over the total testing time. The total permeate mass flux was calculated as:

$$Flux = \frac{m}{A \times t}$$

where m is the mass of the permeate in kilograms (kg); A is the effective membrane area in square meters (m²); and t is the permeate collection duration time in hours (h). The ethanol content of the permeate and the feedstock were measured by gas chromatography (GC) using an Agilent 7890A gas chromatograph. The alcohol content was determined by using a calibration line obtained by running known concentrations of ethanol through the GC and measuring the GC response area. Then the response area measurements of the permeate and feedstock from the GC were obtained and then using the calibration line the % ethanol was determined. Ethanol mass flux was calculated as membrane mass flux multiplied by the ethanol concentration in the permeate.

### Module Performance Evaluation

Ten liters (10 L) fresh regular gasoline as feed was charged into a pressure vessel (or tank) sitting on a mass balance. Feed gasoline was pumped through a heat exchanger to heat up to a defined temperature (as shown in Table 6) before entering into the testing membrane module. The retentate existing from the module returned to the pressure vessel. The feed flow rate was monitored by an in-line flow meter and the gasoline temperature at the module inlet and outlet was monitored as well. The pressure differential from feed inlet and outlet of the module was recorded as cross-module pressure drop. The permeate vapor was drawn into a chilled heater exchanger to condense into a liquid, which was collected in the collection tank. The vacuum was regulated by a control valve in the vacuum pump to maintain 200 Torr.

Mass depletion of the pressure vessel was tracked by the mass balance. Feed gasoline in the pressure vessel was sampled every 5 min or 10 min. The ethanol content of these feed samples was analyzed by Gas Chromatography (GC).

The average module ethanol flux was calculated according to the Equation 1.

$$Flux ( EtOH ) = \frac{{M}_{0} * {c}_{0} - ( {M}_{0} - {M}_{1} ) * {c}_{1}}{t} \qquad ( 1 )$$

M₀ is the mass of feed gasoline in the initial pressure vessel, M₁ is the mass of feed gasoline at the end of the testing, c₀ is the ethanol content in the initial feed and c₁ is ethanol content at the end of the testing, t is the testing time.

The module ethanol selectivity represented by the permeate ethanol content was calculated according to the equation (2).

$$Permeate ( EtOH ) = \frac{Flux ( EtOH )}{( {M}_{0} - {M}_{1} ) / t} \qquad ( 2 )$$

Membrane efficiency in a spiral wound module represents membrane performance difference after converting into a module. The efficiency in terms of EtOH flux is calculated according to the equation (3).

$$Module membrane efficiency = \frac{Module flux ( \frac{kg}{h} ) / membrane area ( {m}^{2} )}{Membrane flux ( \frac{kg}{{m}^{2} h} )} \qquad ( 3 )$$

### Module Vacuum Integrity Test

A fully cured and trimmed module was connected with a vacuum pump at one end of the permeate tube and capped at the opposite end. A full vacuum was applied and the maximum vacuum level achieved was recorded.

### Module Pressure Integrity Test

A fully cured and trimmed module was connected to pressurized nitrogen gas at 6.9 kPa (10 psi) at one end of the permeate tube and capped at the opposite end. A leak detection solution (Oatey all purpose leak detector, Oatey Company, Cleveland, Ohio) was applied to the end of the module and visually checked if any leaking spots were observed. If no leaking spots were observed, the module was considered to have passed the test.

### EXAMPLES

### Examples 1-19

Separation modules were prepared using the following materials from Table 2 and the membranes described below as M1-M7. Construction details are listed in Tables 3 and 4 below as to the membranes, feed spacers, permeate spacers, permeate collection tubes, pore sealants, and adhesives that were used.

TABLE 2
Materials Used

| Designation | Description | Supplier |
|---|---|---|
| LD7240 | Feed spacer (polyester nonoven | Midwest Filtration LLC, |
| | material) | Cincinnati, OH |
| Guilford #45214 | Feed Spacer (polyester tricot textile | Guilford Textile Company, |
| | material) | Wilmington, NC |
| NN1500 | Feed spacer (extruded square nylon | Industrial Netting, |
| | mesh) | Minneapolis, MN |
| NN1000 | Feed spacer (extruded square nylon | Industrial Netting, |
| | mesh) | Minneapolis, MN |
| NN3100 | Feed spacer (extruded diamond | Industrial Netting, |
| | nylon mesh) | Minneapolis, MN |
| WS0200 | Feed spacer (polyester woven | Industrial Netting, |
| | mesh) | Minneapolis, MN |
| WS0300 | Feed spacer (polyester woven | Industrial Netting, |
| | mesh) | Minneapolis, MN |
| PPS #P861 (NALTEX | Feed spacer (polyphenlyene sulfide | Delstar Technologies Inc., |
| N01328_60PPS-NAT) | extruded mesh) | Middledown, DE |
| PBT #P864 (NALTEX | Permeate spacer (polybutylene | Delstar Technologies Inc., |
| N02413/19_45PBTNAT) | terephthalate asymmetrical | Middletown DE |
| | extruded mesh) | |
| EPON828 | Difunctional bisphenol A epoxy | Momentive Company, |
| | resin | Columbus, OH |
| TETA | Triethylenetetramine | Alfa Aesar, Heysham, |
| | | England |
| TTD | 4,7,10-Trioxatridecane-1,13- | BASF Corp. |
| | Diamine | |
| DP760 | SCOTCH-WELD - DP760 epoxy | 3M France, Bd de Poise, |
| | adhesive | Cergy Pontoise Cedex, France |
| AC350-B1/4 | Aerospace polysulfide sealant | 3M Aerospace, St Paul, MN |
| PES2 | Polyethersulfone support | Ultura, Oceanside, CA |
| | membrane | |
| PES900 | Polyethersulfone support | Ultura, Oceanside, CA |
| | membrane | |
| SR344 | Polyethyleneglycol diacrylate | Sartomer Co. Exton, PA |
| SR603OP | Polyethyleneglycol diacrylate | Sartomer Co. Exton, PA |
| DBS | Dibutyl sebecate | Vertellus Performance |
| | | Materials, Inc., Greensboro, |
| | | NC |

### Membrane M1-A, B, C, D, E

A pore-filling polymerizable solution was prepared by mixing 40 wt-% of polyethylene glycol 400 diacrylate (SR344 into 60 wt-% Dibutyl Sebecate (DBS)). A polyethersulfone porous substrate (PES2) was dip coated with the pore-filling polymerizable solution to completely saturate and impregnate the porous substrate. The pore-filled substrate was squeezed between two rolls to remove any excess surface solution and then passed through an ultraviolet (UV) chamber for curing at a speed of 12 meter per minute (n/min) with the tight pore side of the substrate facing the UV source. The chamber was run with an inert atmosphere and was equipped with a Fusion H lamp with an aluminum reflector as the UV source to polymerize and cross-link the diacrylate. The UV cured pore-filled substrate was washed with ethanol to remove any uncured polymer solution, wound into a roll and then dried at room temperature. Five lots/batches of membranes (A, B, C. D, E) were produced at approximately the same process conditions for module fabrication.

### Membrane M2

A pore-filled membrane was produced as in M1 above except that the pore-filling polymerizable solution was prepared by mixing 40 wt-% of polyethylene glycol 400 dimethacrylate (SR603) into 60 wt-% DBS and the curing speed was 15 meter per minute.

### Membrane M3

A pore-filling polymerizable solution was prepared by mixing 40 wt-% of polyethylene glycol 400 diacrylate (SR344) into 60 wt-% DBS. A polyethersulfone porous substrate (PES2) was coated with the pore-filling polymerizable solution on the tight pore side of the membrane. The pore-filled substrate was cured in a ultraviolet (UV) chamber at a speed of 23 m/min with the tight pore side of the substrate facing the UV source. The chamber was run with an inert atmosphere and was equipped with a Fusion H lamp with an aluminum reflector as the UV source to polymerize and cross-link the diacrylate. The UV cured pore-filled substrate was washed with ethanol to remove any uncured polymer solution, wound into a roll, and then dried at room temperature.

### Membrane M4

A pore-filled membrane was produced as in M3 above except the pore-filling polymerizable solution was prepared by mixing 40 wt-% of polyethylene glycol 400 dimethacrylate (SR603) into 60 wt-% DBS. The UV curing was done at 12 m/min.

### Membrane M5

A pore-filled membrane was produced as in ML above except the pore-filling polymerizable solution was prepared by mixing 20 wt-% of polyethylene glycol 400 diacrylate (SR344) into 80 wt-% de-ionized water. The UV curing was done at 6 m/min.

### Membrane M6

A pore-filled membrane was produced as in M2 above except that the pore filled substrate was cured at a speed of 12 m/min.

### Membrane M7

A pore-filled membrane was produced as in M3 except the pore filled substrate was cured at a speed of 18 m/min.

### Membrane M8

A pore-filling polymerizable solution was prepared by mixing 20 wt-% of polyethylene glycol 400 diacrylate (SR344) into de-ionized water. A polyethersulfone porous substrate (PES900) was completely saturated with the pore-filling polymerizable solution. The pore-filled substrate was cured in an ultraviolet (UV) chamber at a speed of 6.1 m/min with the tight pore side of the substrate facing the UV source. The chamber was run with an inert atmosphere and was equipped with a Fusion H lamp with an aluminum reflector as the UV source to polymerize and cross-link the diacrylate. The UV cured pore-filled substrate was washed with water to remove any uncured polymer solution, wound into a roll, and then dried at room temperature.

TABLE 3
Module Construction

| Example | Membrane | Feed Spacer | Permeate Spacer (layer 1/layer 2) | Collection tube |
|---|---|---|---|---|
| 1 | M1-A | NN3100 | NN1000/NN1000 | CPVC |
| 2 | M1-B | LD7240 | NN1000/NN1000 | CPVC |
| | | (2 Layers) | | |
| 3 | M1-C | LD7240 | NN1000/NN1000 | CPVC |
| 4 | M1-D | LD7240 | NN1000/NN1000 | CPVC |
| 5 | M2 | Guilford 45214 | Guilford 45214-PBT P864 | SS |
| | | | (NALTEX | |
| | | | N02413/19_45PBTNAT) | |
| 6 | M3 | Guilford 45214 | Guilford 45214/NN1500 | SS |
| 7 | M3 | LD7240 | Guilford 45214/PBT P864 | SS |
| | | | (NALTEX | |
| | | | N02413/19_45PBTNAT) | |
| 8 | M4 | LD7240 | Guilford 45214/PBT P864 | SS |
| | | | (NALTEX | |
| | | | N02413/19_45P8TNAT) | |
| 9 | M5 | LD7240 | Guilford 45214/PBT P864 | SS |
| | | | (NALTEX | |
| | | | N02413/19_45PBTNAT) | |
| 10 | M5 | LD7240 | Guilford 45214/PBT P864 | SS |
| | | | (NALTEX | |
| | | | N02413/19_45PBTNAT) | |
| 11 | M5 | PPS P861 | Guilford 45214/PBT P864 | SS |
| | | | (NALTEX | |
| | | | N02413/19_45PBTNAT) | |
| 12 | M5 | LD7240 | NN1500/PBT P864 | SS |
| | | | (NALTEX | |
| | | | N02413/19_45PBTNAT) | |
| 13 | M6 | LD7240 | Guilford 45214/PBT P894 | SS |
| | | | (NALTEX | |
| | | | N02413/19_45PBTNAT)/Guilford | |
| | | | 45214 | |
| 14 | M5 | PPS P861 | Guilford 45214/PBT P864 | SS |
| | | | (NALTEX | |
| | | | N02413/19_45PBTNAT)/Guilford | |
| | | | 45214 | |
| 15 | M7 | PPS P861 | Guilford 45214/PBT P864 | SS |
| | | | (NALTEX | |
| | | | N02413/19_45PBTNAT) | |
| 16 | M7 | PPS P861 | Guilford 45214/PBT P864 | SS |
| | | | (NALTEX | |
| | | | N02413/19_45PBTNAT) | |
| 17 | M1-E | WS0200 | WS0300/PBT P864 (NALTEX | SS |
| | | | N02413/19_45PBTNAT)/ | |
| | | | WS0300 | |
| 18 | M1-E | WS0200 | WS0300/PBT P864 (NALTEX | SS |
| | | | N02413/19_45PBTNAT)/ | |
| | | | WS0300 | |
| 19 | M5 | WS0200 | WS0300/PBT P864 (NALTEX | SS |
| | | | N02413/19_45PBTNAT)/ | |
| | | | WS0300 | |

TABLE 4
Module Construction

| | | | | Membrane | |
|---|---|---|---|---|---|
| | | | Membrane | Length for | Number of |
| Example | Pore Sealant | Adhesive | area (m²) | leaf (mm) | leafs |
| 1 | EPON 828/TETA (7/1) | AC350-B1/4 | 0.81 | 600 | 7 |
| 2 | EPON 828/TETA (7/1) | AC350-B1/4 | 0.81 | 620 | 7 |
| 3 | EPON 828/TETA (7/1) | AC350-B1/4 | 0.92 | 600 | 8 |
| 4 | EPON 828/TETA (7/1) | AC350-B1/4 | 1.04 | 600 | 9 |
| 5 | EPON 828/TETA (7/1) | DP760 | 0.90 | 500 | 10 |
| 6 | EPON 828/TETA (7/1) | DP760 | 0.95 | 500 | 8 |
| 7 | EPON 828/TETA (7/1) | DP760 | 0.98 | 500 | 12 |
| 8 | EPON 828/TETA (7/1) | DP760 | 0.98 | 500 | 12 |
| 9 | EPON 828/TETA (7/1) | DP760 | 1.14 | 500 | 14 |
| 10 | EPON 828/TETA (7/1) | DP760 | 1.31 | 500 | 16 |
| 11 | EPON 828/TETA (7/1) | DP760 | 1.14 | 500 | 14 |
| 12 | EPON 828/TETA (7/1) | DP760 | 1.14 | 500 | 14 |
| 13 | EPON 828/TETA (7/1) | DP760 | 1.14 | 500 | 14 |
| 14 | EPON 828/TETA (7/1) | DP760 | 0.98 | 500 | 12 |
| 15 | EPON 828/TETA (7/1) | DP760 | 1.33 | 600 | 12 |
| 16 | EPON 828/TETA (7/1) | DP760 | 1.33 | 600 | 12 |
| 17 | EPON | DP760 | 1.13 | 600 | 10 |
| | 828/TETA/DP760 | | | | |
| | (21/3/8) | | | | |
| 18 | EPON | DP760 | 1.13 | 600 | 10 |
| | 828/TETA/DP760 | | | | |
| | (21/3/8) | | | | |
| 19 | EPON | DP760 | 0.83 | 500 | 9 |
| | 828/TETA/DP760 | | | | |
| | (21/3/8) | | | | |

TABLE 5
Module Construction

| | Module Volume | Module vacuum | Module pressure |
|---|---|---|---|
| Example | (liters) | integrity (kPa) | integrity (69 kPa N₂) |
| 1 | 0.96 | — | Pass |
| 2 | 0.88 | — | Pass |
| 3 | 0.93 | 5.8 | — |
| 4 | 0.98 | 5.3 | — |
| 5 | 0.94 | 1.2 | — |
| 6 | — | 1.7 | — |
| 7 | 0.94 | 1.6 | — |
| 8 | 0.93 | 1.6 | — |
| 9 | 1.18 | 1.3 | — |
| 10 | 1.36 | 1.8 | — |
| 11 | — | 2.0 | — |
| 12 | — | 3.3 | — |
| 13 | — | 2.2 | — |
| 14 | 1.32 | 2.0 | — |
| 15 | 1.34 | 2.4 | — |
| 16 | 1.32 | 2.3 | — |
| 17 | 1.37 | 1.6 | — |
| 18 | 1.29 | 1.7 | — |
| 19 | 0.93 | 1.6 | — |

TABLE 6

| | Module | Module | Module | Gasoline | Feed Flow |
|---|---|---|---|---|---|
| | Permeate | EtOH flux | membrane | Feed | Rate |
| Example | EtOH | (kg/m²h) | efficiency | Temp (° C.) | (mL/min) |
| 1 | 47.3% | 1.11 | 72% | 77.7 | 2613 |
| 2 | 38.6% | 1.06 | 72% | 76.8 | 2184 |
| 3 | 48.8% | 0.93 | 49% | 78.0 | 2090 |
| 4 | 41.0% | 1.04 | 47% | 72.0 | 2010 |
| 5 | 37.0% | 0.84 | 54% | 69.6 | 2340 |
| 6 | 46.3% | 0.79 | 69% | 70.4 | 1874 |
| 7 | 58.9% | 0.86 | 72% | 70.7 | 2094 |
| 8 | — | 0.99 | 77% | 70.4 | 1906 |
| 9 | 49.8% | 1.04 | 65% | 71.9 | 1914 |
| 10 | 48.9% | 1.04 | 57% | 72.0 | 1968 |
| 11 | 46.0% | 0.86 | 54% | 71.8 | 1804 |
| 12 | 36.0% | 0.96 | 60% | 71.6 | 2046 |
| 13 | 26.1% | 1.07 | 42% | 70.4 | 1931 |
| 14 | 41.2% | 0.87 | 64% | 71.5 | 2088 |
| 15 | 42.1% | 0.91 | 85% | 72.8 | 2004 |
| 16 | 35.0% | 0.86 | 81% | 72.5 | 2039 |
| 17 | 40.9% | 1.20 | 70% | 71.0 | 2000 |
| 18 | 52.6% | 1.42 | 83% | 71.5 | 2022 |
| 19 | 61.5% | 0.89 | 77% | 72.2 | 2016 |

TABLE 7

| | Average | |
|---|---|---|
| | Permeate EtOH | Average EtOH |
| Membrane | concentration | flux (kg/m²h) |
| M1-A | 62.3% | 1.90 |
| M1-B | 57.2% | 1.81 |
| M1-C | 54.8% | 2.07 |
| M1-D | 57.5% | 2.15 |
| M1-E | 53.9% | 1.52 |
| M2 | 48.4% | 1.73 |
| M3 | 60.9% | 1.21 |
| M4 | 59.8% | 1.31 |
| M5 | 72.6% | 1.40 |
| M6 | 54.9% | 2.23 |
| M7 | 81.4% | 0.80 |

### Module Assembly

### Examples 1-16

Membrane modules were prepared by the following procedure using the materials in Tables 2, 3, and 4 and generally depicted in FIG. 5. Membrane sheets were pre-cut (25.4 cm width) and folded. The membrane folder was inserted with various feed spacer materials. Pore sealant was mixed from EPON 828 and TETA at a 7:1 weight ratio. The sealant was applied to the edges of the membrane folder and cured at 71° C. for 1 hour. The membrane folders with cured sealed edges were then stacked with a permeated spacer and an adhesive was applied to seal the permeate spacers between the membrane folders such that the permeate spacers remained open to the permeate collection tube. The stack of membrane folders and permeate spacers were wound around a perforated permeate collection tube to form a module. The collection tube had approximately 50-75% open area/perforations. Two different types of permeate collection tubes were used—a CPVC (chlorinated polyvinyl chloride) tube having dimensions of 17 mm outside diameter and 33 cm in length; and a stainless steel (SS) tube having dimensions of 13 mm outside diameter and 51 cm in length. The module was then cured at 80° C. for at least 12 hours in a Thelco Laboratory Oven (Thermo Fischer Scientific Inc.). The module was then trimmed at two ends to expose the feed spacers before commencing the integrity testing. After the module was integrity tested it was housed in a stainless steel canister for performance evaluation.

### Examples 17-19

Membrane modules were prepared as in Examples 1-16 above except the pore sealant was prepared with EPON 828, TETA, and DP760 in a 21:3:8 weight ratio.

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A separation module comprising at least one separation leaf comprising:
first and second asymmetric composite membranes having a permeate mesh spacer sandwiched between the first and second asymmetric composite membranes; and
an edge-seal bond that adheres the first and second asymmetric composite membranes and permeate spacer together;
wherein the first and second asymmetric composite membranes comprise pores and the permeate spacer comprise mesh openings; and
wherein the edge-seal bond comprises:
a pore-filling sealant within at least a portion of the pores of the first and second membranes; and
an adhesive within at least a portion of the mesh openings of the permeate spacer;
wherein the pore-filling sealant is distinct from the adhesive.

2. The separation module of claim 1 wherein the pore-filling sealant and adhesive comprise different compositions.

3. The separation module of claim 2 wherein the pore-filling sealant and adhesive have different viscosities when applied to form the edge seal bond.

4. The separation module of claim 2 wherein at least one of the pore-filling sealant composition and adhesive composition includes an adhesion promoter, a corrosion inhibitor, a rheology controlling agent, or a combination thereof.

5. The separation module of claim 1 wherein the permeate spacer comprises at least one large mesh layer having large mesh openings.

6. The separation module of claim 5 wherein the permeate spacer further comprises at least one small mesh layer having small mesh openings.

7. The separation module of claim 6 wherein the permeate spacer comprises first and second small mesh layers and the large mesh layer sandwiched between the first and second small mesh layers.

8. The separation module of claim 5 wherein the adhesive fills the large mesh openings of the at least one large mesh layer of the permeate spacer within the edge-seal bond.

9. The separation module of claim 5 wherein the pore-filling sealant and/or the adhesive fills the small mesh openings of the at least one small mesh layer of the permeate spacer within the edge-seal bond.

10. The separation module of claim 1 wherein the asymmetric composite membranes comprise:
a porous substrate comprising opposite first and second major surfaces, and a plurality of pores; and
a pore-filling polymer disposed in at least some of the pores so as to form a layer having a thickness within the porous substrate, with the amount of the polymer at or adjacent to the first major surface being greater than the amount of the polymer at or adjacent to the second major surface.

11. The separation module of claim 10 wherein the porous substrate of each asymmetric composite membrane comprises a nanoporous layer, a macroporous layer, and a microporous layer sandwiched between the nanoporous layer and the macroporous layer, wherein the macroporous layer of each membrane is positioned adjacent to the permeate spacer.

12. The separation module of claim 11 wherein the pore-filling sealant fills the pores of the microporous layer of the porous substrate of the asymmetric composite membrane within the edge-seal bond.

13. The separation module of claim 11 wherein the pore-filling sealant and/or the adhesive fills the pores of the macroporous layer of the porous substrate of the asymmetric composite membrane within the edge-sealing bond.

14. The separation module of claim 1 wherein the pore-filling sealant and/or the adhesive comprises an epoxy.

15. A fuel separation system comprising the separation module of claim 1.

16. A method of separating ethanol from a mixture of ethanol and gasoline, the method comprising contacting the mixture with a separation module of claim 1.

17. A method of making a separation module comprising at least one separation leaf comprising first and second asymmetric composite membranes having a permeate spacer sandwiched between the first and second asymmetric composite membranes, wherein the first and second asymmetric composite membranes comprise pores and the permeate spacer comprises mesh openings; the method comprising:
applying a pore-filling sealant adjacent to at least one edge of each membrane, wherein the pore-filling sealant has a viscosity sufficient to fill at least a portion of the pores of the membrane;
applying an adhesive adjacent to at least one edge of the permeate spacer, wherein the adhesive has a viscosity sufficient to fill at least a portion of the mesh openings of the permeate spacer; and
forming an edge-seal bond between the pore-filling sealant and adhesive that adheres the first and second asymmetric composite membranes and permeate spacer together;
wherein the pore-filling sealant viscosity is lower than the adhesive viscosity when applied.

18. The method of claim 17 wherein the pore-filling sealant and the adhesive are applied at different temperatures.

19. The method of claim 17 wherein the pore-filling sealant and adhesive are distinct compositions.

20. The method of claim 17 wherein the asymmetric composite membranes comprise:
a porous substrate comprising opposite first and second major surfaces, and a plurality of pores; and
a pore-filling polymer disposed in at least some of the pores so as to form a layer having a thickness within the porous substrate, with the amount of the polymer at or adjacent to the first major surface being greater than the amount of the polymer at or adjacent to the second major surface.
